(19) United States
(12) Patent Application Publication
(10) Pub. No.: US 2018/0243691 A1
(43) Pub. Date: Aug. 30, 2018

(54) TERNARY INTERMETALLIC COMPOUND CATALYST

(71) Applicant: BASF SE, Ludwigshafen (DE)

(72) Inventors: Ulrich MUELLER, Ludwigshafen (DE); Andreas SUNDERMANN, Heidelberg (DE); Natalia TRUKHAN, Ludwigshafen (DE); Stefan MAURER, Shanghai (CN); Stefan ERNST, Bad Homburg (DE); Natalja PALUCH, Kaiserslautern (DE); Oliver MALTER, Kaiserslautern (DE); Axel SCHUESSLER, Kaiserslautern (DE)

(73) Assignee: BASF SE, Ludwigshafen (DE)

(21) Appl. No.: 15/752,991

(22) PCT Filed: Aug. 10, 2016
(86) PCT No.: PCT/EP2016/069031

§ 371 Date: Feb. 15, 2018

(30) Foreign Application Priority Data
Aug. 17, 2015 (EP) 15181268.2

(51) Int. Cl. B01D 53/94; B01J 21/08; B01J 23/825

(52) U.S. Cl. CPC B01D 53/9418; B01J 21/08; B01J 23/825; B01D 2255/9207; B01D 2255/2092; B01D 2255/20746; B01D 2255/2073; B01D 2255/20738; B01D 2255/9202

(57) ABSTRACT

The present invention relates to a catalyst comprising particles of a ternary intermetallic compound of the following formula (I): X₂YZ wherein X, Y, and Z are different from one another; X being selected from the group consisting of Mn, Fe, Co, Ni, Cu, and Pd; Y being selected from the group consisting of V, Mn, Cu, Ti, and Fe; and Z being selected from the group consisting of Al, Si, Ga, Ge, In, Sn, and Sb; wherein the particles of the ternary intermetallic compound are supported on a support material, as well as to a method for its production and to its use as a catalyst, and more specifically as a catalyst in a process for the condensation of a carbonyl compound with a methylene group containing compound or for the selective catalytic reduction of nitrogen oxides in exhaust gas.

### TECHNICAL FIELD

The present invention relates to a catalyst comprising particles of a ternary intermetallic compound as well as to a method for its preparation. Furthermore, the present invention relates to a process for the condensation of a carbonyl compound with a methylene group containing compound employing the inventive catalyst as well as to the use of the inventive catalyst in general and in particular in the aforementioned method and for the selective catalytic reduction of nitrogen oxides in exhaust gas.

### INTRODUCTION

Heusler phases are intermetallic compounds with X₂YZ composition. X and Y are transition metals (Co, Cu, Fe, Mn) and Z is a 3^{rd}/4^{rd} row main group element (Ge, Si, Al, Ga). Since their discovery, the main interest for said compounds mainly focused on ferromagnetic applications such as in spintronics, thermoelectrics, and giant magnetoresistance. In particular, their catalytic properties were barely touched such as e.g. in Hedin et al. in Z. physik. Chem. 1935, B30 280-288 which is a study on how changes in ferromagnetism may influence catalytic reactions such as the hydrogenation of carbon monoxide and ethylene over nickel and the oxidation of carbon monoxide to carbon dioxide over the Heusler alloy MnAlCu₂.

There however remains a need for new applications of ternary intermetallic compounds having the X₂YZ composition in other fields that those focused on their magnetic properties.

### DETAILED DESCRIPTION

Accordingly, it was the object of the present invention to provide new applications for ternary intermetallic compounds with the X₂YZ composition and in particular for Heusler alloys of said composition. Thus, it has quite surprisingly been found that when employed in the form of particles supported on a support material, ternary intermetallic compounds of the aforementioned composition may effectively catalyze complex chemical reactions such as the condensation of a carbonyl compound with a methylene group containing compound such as in a Knoevenagel condensation or for the selective catalytic reduction of nitrogen oxides in exhaust gas.

Therefore, the present invention relates to a catalyst comprising particles of a ternary intermetallic compound of the following formula (I):

X₂YZ (I)

wherein X, Y, and Z are different from one another;
X being selected from the group consisting of Mn, Fe, Co, Ni, Cu, and Pd;
Y being selected from the group consisting of V, Mn, Cu, Ti, and Fe; and
Z being selected from the group consisting of Al, Si, Ga, Ge, In, Sn, and Sb;
wherein the particles of the ternary intermetallic compound are supported on a support material.

As regards the element X in the ternary intermetallic compound of formula (I), it is preferred that said element is selected from the group consisting of Mn, Fe, Co, Ni, and Cu, wherein more preferably X is selected from the group consisting of Fe, Co, Ni, and Cu. According to the present invention it is particularly preferred that X is selected from the group consisting of Fe, Co, and Cu, wherein even more preferably X is Co and/or Cu. According to the present invention it is however particularly preferred that the element in the ternary intermetallic compound of formula (I) is Cu.

With respect to the element Y contained in the ternary intermetallic compound of formula (I) comprised in the inventive catalyst, it is preferred that said element is selected from the group consisting of Cu, Mn, Fe, and Ti. According to the present invention it is particularly, preferred that Y is Mn and/or Fe: However, according to the present invention it is particularly preferred that the element Y contained in the ternary intermetallic compound of formula (I) is Fe.

Concerning the element Z of the ternary intermetallic compound of formula (I) contained in the inventive catalyst, it is preferred that said element is selected from the group consisting of Al, Si, Ga, Ge, In, Sn, and Sb, wherein more preferably, Z is selected from the group consisting of Al, Si, Ga, and In. According to the present invention it is further preferred that the element Z contained in the ternary intermetallic compound of formula (I) is selected from the group consisting of Al, Si, and Ga, wherein even more preferably Z is Al and/or Si. According to the present invention it is however, particularly preferred that the element Z contained in the ternary intermetallic compound of formula (I) comprised in the inventive catalyst is Al.

As regards the ternary intermetallic compound of formula (I) contained in the inventive catalyst, no particular restrictions apply relative to the combination of elements which may be contained therein for affording a compound X₂YZ provided that X is selected from the group consisting of Mn, Fe, Co, Ni, Cu, and Pd, Y is selected from the group consisting of V, Mn, Cu, Ti, and Fe, and Z is selected from the group of Al, Si, Ga, Ge, In, Sn, and Sb, provided that X, Y, and Z are different from one another. Thus, any conceivable combinations of the aforementioned elements X, Y, and Z may constitute the ternary intermetallic compound comprised in the inventive catalyst again provided that said elements X, Y, and Z are different from one another. It is, however, preferred according to the present invention that the catalyst comprises particles of a ternary intermetallic compound of the formula (I) wherein X is selected from the group consisting of Mn, Fe, Co, Ni, and Cu, Y is selected from the group consisting of Cu. Mn, Fe, and Ti, and Z is selected from the group consisting of Al, Si, Ga, Ge, In, Sn, and Sb. According to the present invention it is yet further preferred that the ternary intermetallic compound comprised in the inventive catalyst has the formula (I) wherein X is selected from the group consisting of Fe, Co, Ni, and Cu, Y is selected from the group consisting of Cu, Mn, Fe, and Ti, and Z is selected from the group consisting of Al, Si, Ga, and In. Even more preferably, the inventive catalyst comprises particles of a ternary intermetallic compound of the formula (I) wherein X is selected from the group consisting of Fe, Co, and Cu, Y is selected from the group consisting of Cu, Mn, Fe, and Ti, and Z is selected from the group consisting of Al, Si, and Ga. According to the present invention it is particularly preferred that ternary intermetallic compound of the formula (I) comprised in the inventive catalyst has a composition wherein X is Co and/or Cu, Y is Mn and/or Fe, and Z is Al and/or Si.

Thus, by way of example, the ternary intermetallic compound comprised in the inventive catalyst may be selected from the group consisting of Co₂FeAl, Co₂FeSi, Co₂FeGa, Co₂FeIn, Cu₂FeAl, Cu₂FeSi, Fe₂MnGa, Fe₂MnSi, Co₂CuAl, Fe₂TiGa, including mixtures of any two or more thereof. Preferably, however, the ternary intermetallic compound of the inventive catalyst is selected from the group consisting of Co₂FeAl, Co₂FeSi, Cu₂FeAl, Cu₂FeSi, Co₂CuAl, Fe₂MnSi, including mixtures of any two or more thereof, and more preferably from the group consisting of Cu₂FeAl, Cu₂FeSi, Co₂CuAl, Fe₂MnSi, including mixtures of any two or more thereof. According to the present invention it is particularly preferred that the ternary intermetallic compound comprised in the inventive catalyst comprises Cu₂FeAl and/or Cu₂FeSi, and preferably comprises Cu₂FeAl, wherein even more preferably the ternary intermetallic compound comprised in the inventive catalyst is Cu₂FeAl and/or Cu₂FeSi, and is preferably Cu₂FeAl.

As regards the structure of the ternary intermetallic compound of the formula (I) contained in the inventive catalyst, no particular restrictions apply such that the intermetallic compound may display any suitable structure provided that it may form at least one crystalline phase. As regards the crystalline phases which may be formed by the ternary intermetallic compound of the formula (I), again no particular restrictions apply wherein it is however preferred that the intermetallic compound is a Heusler phase.

With respect to the size of the particles of the ternary intermetallic compound contained in the inventive catalyst, no particular restrictions apply. Thus, any conceivable particle sizes may be employed, wherein preferably the mean particle size D50 of the particular intermetallic compound in the inventive catalyst is in the range of anywhere from 3 nm to 2 μm. Preferably, however, the mean particle size D50 of the particles of the intermetallic compound of the formula (I) is in the range of from 5 nm to 1.5 μm, and more preferably in the range of 10 nm to 1 μm, more preferably in the range of 20 nm to 700 nm, more preferably in the range of 30 nm to 500 nm, more preferably in the range of 40 nm to 300 nm, more preferably in the range of 50 nm to 200 nm, more preferably in the range of 60 nm to 150 nm, more preferably in the range of 70 nm to 120 nm, more preferably in the range of 80 nm to 100 nm, and more preferably in the range of 85 nm to 90 nm.

According to the present invention, there is no particular restriction as to the method according to which the average particle size D50 of the particles of the ternary intermetallic compound of the formula (I) contained in the inventive catalyst is determined. According to the present invention it is preferred that the particle size is determined by small-angle X-ray scattering (SAXS) or, alternatively, by analyzing the broadening of the reflections in the X-ray diffraction pattern of the particles of the ternary intermetallic compound, preferably by fourier methods (cf. e.g. Warren and Averbach, J. Appl. Phys. 1950, 21, 596 (1950)) or by Double Voigt Methods (cf. e.g. D. Balzar, “Voigt-Function Model in Diffraction Line-Broadening Analysis”, in Defect and Microstructure Analysis from Diffraction, edited by R. L. Snyder, H. J. Bunge, and J. Fiala, International Union of Crystallography Monographs on Crystallography No. 10 (Oxford University Press, New York, 1999) pp. 94-126). To this effect, the particles of the ternary intermetallic compound of the inventive catalyst are separated from the support and then analyzed by one of the aforementioned methods. For isolating the particles from the inventive catalyst, any suitable method may be employed wherein it is particularly preferred according to the present invention that to this effect the particles of the ternary intermetallic compound are first coated with carbon by heating the catalyst within 75 min to 850° C. and maintaining said temperature for 5 h, subsequently carbon coating the sample by exposing it to a methane flow (e.g. at a flow rate of 100 ml·min⁻¹) for 5 min at 850° C., and cooling the sample to room temperature, after which the support may be chemically dissolved or disintegrated with the aid of an agent which suitably reacts with the substrate material of the catalyst. According to particularly preferred embodiments of the present invention wherein the support material is silica, it is particularly preferred that the catalyst containing the carbon coated particles is suspended in HF solution (10% aq.) for 1 h in order to remove the silica support and subsequently centrifuged at 6,000 rpm for 30 min, the HF solution removed, the free standing carbon coated particles repeatedly (3×) washed with distilled water an centrifuged in the aforementioned manner prior to removing the supernatant, after which the particles are analyzed via SAXS or, alternatively, by analyzing the broadening of the reflections in the X-ray diffraction pattern of the particles.

It is particularly preferred according to the present invention that the values for the average particle size D50 of the particles of the intermetallic compound supported on the support material in the inventive catalyst according to particular and preferred embodiments of the present invention are determined by small-angle X-ray scattering performed on the inventive catalyst according to ISO 17867:2015.

According to the present invention it is alternatively preferred that the average particle size D50 of the particles of the ternary intermetallic compound of the formula (I) contained in the inventive catalyst is determined by Scanning Electron Microscopy (SEM) or Transmission Electron Microscopy (TEM), preferably by High Angle Annular Dark Field-Scanning Transmission Electron Microscopy (HAADF-STEM) and/or by Scanning Electron Microscopy with detection of backscattered electrons (SEM-BSE) at 20 kV, and more preferably by HAADF-STEM. According to the present invention, the analysis by SEM or TEM according to any of the particular and preferred embodiments may be conducted on the inventive catalyst per se including the support material or, alternatively, on the particles of the ternary intermetallic compound of the inventive catalyst after these have been separated from the support. For isolating the particles from the inventive catalyst, again, any suitable method may be employed, wherein it is particularly preferred according to the present invention that the particles of the ternary intermetallic compound are isolated according to the particular and preferred methods as described in the foregoing relative to the SAXS and X-ray diffraction line broadening methods. According to the present invention it is particularly preferred that after having separated the particles of the ternary intermetallic compound, the free standing particles are dispersed in ethanol, the mixture then loaded on a copper grid, and dried in air for subsequent analysis by SEM or TEM.

As regards the method employed for measuring and evaluating the SEM or TEM images for determining the average particle size D50 according to the aforementioned particular and preferred methods, no particular restrictions apply, wherein it is particularly preferred that the analysis and evaluation is performed according to ISO 13322-1:2014. According to preferred embodiments of the present invention wherein the average particle size D50 of the particles of the ternary intermetallic compound of the formula (I) contained in the inventive catalyst is determined by HAADF-STEM, it is particularly preferred that the analysis and evaluation is performed as generally defined in the experimental section of the present patent application.

In instances wherein the average particle size D50 of the ternary intermetallic compound particles is determined by SEM or TEM according to any of the particular and preferred methods defined in the present application, the average particle size D50 preferably refers to the minimum particle diameter. Furthermore, it is preferred that the average particle size D50 refers to the particle size by volume or by number, and particularly preferably by number. As regards the range of particle sizes considered for determining the D50 values of the ternary intermetallic compound particles by SEM or TEM, no particular range applies, such that principally all ternary intermetallic compound particle sizes present in the inventive catalyst are considered to the effect of determining the D50 value. According to the present invention, it is however particularly preferred that the average particle size D50 of the ternary intermetallic compound particles refers to the average particle size D50 or the particle fraction having a minimum diameter of 1 μm or less, more preferably of 800 nm or less, more preferably of 600 nm or less, more preferably of 500 nm or less, more preferably of 450 nm or less, and even more preferably of 400 nm or less.

Therefore, according to the present invention it is preferred that the particular and preferred values for the average particle size D50 of the particles of the ternary intermetallic compound of the formula (I) contained in the inventive catalyst refers to the D50 values obtained according to any of the particular and preferred methods for determining the average particle size as defined in the present application.

The inventive catalyst comprising particles of a ternary intermetallic compound further contains a support material onto which the ternary intermetallic compounds are provided. To this effect, any suitable support material may be employed to this effect. It is, however, preferred according to the present invention that the support material comprises one or more metal oxides and/or one or more metalloid oxides. To this effect, any suitable metal oxides and/or metalloid oxides may be employed to this effect. Thus, by way of example, the one or more metal oxides and/or metalloid oxides preferably comprised in the support material of the inventive catalyst may be selected from the group consisting of silica, alumina, silica-alumina, titania, zirconia, as well as mixtures of any two or more of the aforementioned oxides. Preferably, however, the support material of the inventive catalyst comprises one or more metal oxides and/or metalloid oxides selected from the group consisting of silica, gamma-alumina, silica-alumina, including mixtures of any two or more of the aforementioned oxides. It is, however, particularly preferred according to the present invention that the support material comprises silica and/or gamma-alumina, wherein even more preferably the support material is silica, gamma-alumina, or a mixture of both silica and gamma-alumina. According to the present invention it is particularly preferred that the support material comprised in the inventive catalyst is either silica or gamma-alumina.

As regards the chemical and physical properties of the support material contained in the inventive catalyst and in particular the chemical and physical properties of the preferred one or more metal oxides and/or metalloid oxides comprised in said support material, no particular restrictions apply such that in principle any conceivable support material and in particular any conceivable metal oxides and/or metalloid oxides may be comprised therein. Thus, by way of example, the BET surface area of the one or more metal oxides and/or metalloid oxides preferably comprised in the support material may range anywhere from 150 to 500 m²/g, wherein it is preferred that the surface area of the one or more metal oxides and/or metalloid oxides ranges from 200 to 450 m²/g, and more preferably from 220 to 410 m²/g, and more preferably from 250 to 380 m²/g. According to the present invention it is particularly preferred that the BET surface area of the one or more metal oxides and/or metalloid oxides is in the range of from 280 to 350 m²/g. Within the meaning of the present invention, the surface area of the one or more metal oxides and/or metalloid oxides comprised in the support material refers to the surface area thereof without having the ternary intermetallic compound provided thereon, i.e. prior to the loading thereof with the ternary intermetallic compound, and preferably refers to the surface area of the metal oxides and/or metalloid oxides in the calcined state, such as e.g. after having been calcined in air at 550° C. for 2 h. Furthermore, according to the present invention, the values for the BET surface area refer to those which are determined according to ISO 9277 or DIN 66131, wherein the values for the BET surface area refer to those obtained according to ISO 9277.

Concerning the respective amounts of ternary intermetallic compound and support material respectively comprised in the inventive catalyst, again no particular restrictions apply such that any conceivable amounts thereof may be contained in the inventive catalyst and accordingly any conceivable weight ratios of the ternary intermetallic compound of formula (I) to the support material and, according to particular and preferred embodiments of the present invention, of the ternary intermetallic compound to the one or more metal oxides and/or metalloid oxides preferably comprised in the support material. Thus, by way of example, as concerns the weight ratio of the ternary intermetallic compound of formula (I) to the one or more metal oxides and/or metalloid oxides according to any of the particular and preferred embodiments of the present invention, it may range anywhere from 0.5:99.5 to 50:50, wherein preferably the weight ratio of the ternary intermetallic compound to the one or more metal oxides and/or metalloid oxides is in the range of from 1:99 to 30:70, and more preferably from 3:97 to 20:80, more preferably from 5:95 to 15:85, more preferably from 6:94 to 12:88, and more preferably from 7:93 to 11:89. According to the present invention it is particularly preferred that the weight ratio of the ternary intermetallic compound of formula (I) to the one or more metal oxides and/or metalloid oxides preferably comprised in the support material ranges from 8:92 to 10:90.

The present invention further relates to a method for the preparation of the inventive catalyst containing a ternary intermetallic compound according to the following formula (I) supported on a support material according to any of the particular and preferred embodiments described in the foregoing. In particular, the present invention further relates to a method for the preparation of a catalyst containing a ternary intermetallic compound of the following formula (I):

X₂YZ (I)

wherein X, Y, and Z are different from one another, comprising:
(1) providing a solution containing one or more precursor compounds for X, one or more precursor compounds for Y, one or more precursor compounds for Z, and one or more solvents;
(2) adding a support material to the solution provided in (1);
(3) evaporating the mixture obtained in (2) to dryness; and
(4) heating the mixture obtained in (3) in a hydrogen containing atmosphere,
   wherein X is selected from the group consisting of Mn, Fe, Co, Ni, Cu, and Pd;
   Y is selected from the group consisting of V, Mn, Cu, Ti, and Fe; and
   Z is selected from the group consisting of Al, Si, Ga, Ge, In, Sn, and Sb.

As regards the element X of the one or more precursor compounds for X provided in step (1) of the method for the preparation of the inventive catalyst containing the ternary intermetallic compound of formula (I), it is preferred that said element is selected from the group consisting of Mn, Fe, Co, Ni, and Cu, wherein more preferably X is selected from the group consisting of Fe, Co, Ni, and Cu. According to the present invention it is particularly preferred that X is selected from the group consisting of Fe, Co, and Cu, wherein even more preferably X is Co and/or Cu. According to the present invention it is however particularly preferred that the element in the ternary intermetallic compound of formula (I) is Cu.

Concerning the element Y of the one or more precursor compounds for Y provided in step (1) of the method for the preparation of the inventive catalyst containing the ternary intermetallic compound of formula (I), it is preferred that said element is selected from the group consisting of Cu, Mn, Fe, and Ti. According to the present invention it is particularly, preferred that Y is Mn and/or Fe: However, according to the present invention it is particularly preferred that the element Y contained in the ternary intermetallic compound of formula (I) is Fe.

With respect to the element Z of the one or more precursor compounds for Z provided in step (1) of the method for the preparation of the inventive catalyst containing the ternary intermetallic compound of formula (I), it is preferred that said element is selected from the group consisting of Al, Si, Ga, Ge, In, Sn, and Sb, wherein more preferably, Z is selected from the group consisting of Al, Si, Ga, and In. According to the present invention it is further preferred that the element Z contained in the ternary intermetallic compound of formula (I) is selected from the group consisting of Al, Si, and Ga, wherein even more preferably Z is Al and/or Si. According to the present invention it is however, particularly preferred that the element Z contained in the ternary intermetallic compound of formula (I) comprised in the inventive catalyst is Al.

As regards the one or more precursor compounds respectively used for X, Y, and Z, respectively, no particular restrictions apply neither with respect to the number nor with respect to the type of precursor compounds which may be employed for providing a solution in step (1) of the inventive method provided that a ternary intermetallic compound of the formula (I) may be obtained. Thus, by way of example, the one or more precursor compounds for X, Y, and Z may, independently from one another, be selected from the group consisting of salts of the respective element X, Y, and/or Z. Thus, as regards the one or more precursor compounds for X, these may be selected from the group consisting of salts of X, such as for example salts of X selected from the group consisting of acetates, acetylacetonates, nitrates, nitrites, sulfates, hydrogensulfates, dihydrogensulfates, sulfites, hydrogensulfites, phosphates, hydrogenphosphates, dihydrogenphosphates, halides, cyanides, cyanates, isocyanates, and mixtures of any two or more thereof. It is, however, preferred according to the inventive method that the preferred salts of X are selected from the group consisting of acetates, acetylacetonates, nitrates, chlorides, bromides, fluorides, and mixtures of any two or more thereof, wherein more preferably the salts of X are selected from the group consisting of acetates, acetylacetonates, nitrates, chlorides and mixtures of any two or more thereof. According to the inventive method it is particularly preferred that one or more acetates, acetylacetonates, nitrates and/or chlorides are employed as the one or more precursor compounds of X in step (1).

Same applies accordingly relative to the one or more precursor compounds for Y employed in step (1) such that with respect to the preferred salts of Y employed to this effect these are preferably selected from the group consisting of acetates, acetylacetonates, nitrates, nitrites, sulfates, hydrogensulfites, dihydrogensulfates, sulfites, hydrogensulfites, phosphates, hydrogenphosphates, dihydrogenphosphates, halides, cyanides, cyanates, isocyanates, and mixtures of two or more thereof. According to the inventive method it is however preferred that the salts of Y preferably used as the one or more precursor compounds for Y are selected from the group consisting of acetates, acetylacetonates, nitrates, chlorides, bromides, fluorides, and mixtures of two or more thereof. According to the present invention it is particularly preferred that in the inventive method one or more acetates, acetylacetonates, and/or nitrates are employed as the one or more precursor compounds of Y.

As concerns the one or more precursor compounds for Z employed in the inventive method these are again preferably selected from the group consisting of salts of Z, wherein more preferably the salts of Z are selected from the group consisting of C1-C4 alkoxides, acetates, nitrates, nitrites, sulfates, hydrogensulfates, dihydrogensulfates, sulfites, hydrogensulfites, phosphates, hydrogenphosphates, dihydrogenphosphates, halides, cyanides, cyanates, isocyanates, and mixtures of any two or more thereof. More preferably, the salts of Z preferably employed as the one or more precursor compounds in step (1) of the inventive method are selected from the group consisting of C2-C3 alkoxides, acetates, nitrates, chlorides, bromides, fluorides, and mixtures of any two or more thereof. According to the present invention it is particularly preferred that the one or more precursor compounds for Z are one or more salts of Z selected from the group consisting of ethoxides, acetates, nitrates, chlorides, and mixtures of two or more thereof.

As regards the solvents provided in step (1) of the inventive method, no particular restrictions apply provided that at least a portion of the one or more precursor compounds for X, Y, and/or Z may be dissolved therein and preferably the one or more precursor compounds for X, Y, and Z may be entirely dissolved therein. Thus, in particular with respect to the preferred salts of X, Y, and/or Z employed as the one or more precursor compounds thereof in step (1) it is preferred that the one or more solvents provided in step (1) are selected from the group consisting of polar solvents, wherein more preferably the one or more solvents are selected from the group consisting of polar protic solvents. Among the preferred polar protic solvents provided as the one or more solvents in step (1) of the inventive method, it is preferred that these are selected from the group consisting of water, C1-C4 alcohols, and mixtures of two or more thereof, wherein more preferably the preferred one or more polar protic solvents are selected from the group consisting of water, C1-C3 alcohols, and mixtures of two or more thereof. According to the inventive method is particularly preferred that the one or more solvents provided in step (1) are selected from the group consisting of water, methanol, ethanol, and mixtures of two or three thereof, wherein even more preferably the one or more solvents comprise water and/or methanol, and preferably water. According to the present invention it is particularly preferred that distilled water is employed as the solvent in the inventive method.

As regards the support which may be added in step (2) of the inventive method, no particular restrictions apply such that in principle any conceivable support material may be employed therein. According to the present invention, it is however preferred that the support material comprises one or more metal oxides and/or metalloid oxides. As regards said preferred support materials, no particular restrictions apply relative to the number and/or type of metal oxides and/or metalloid oxides which may be provided as support material in step (2). Thus, by way of example, the preferred one or more metal oxides and/or metalloid oxides comprised in the support material may be selected from the group consisting of silica, alumina, silica-alumina, titania, zirconia, and mixtures of any two or more thereof. It is, however, preferred according to the inventive method that the preferred one or more metal oxides and/or metalloid oxides are selected from the group consisting of silica, gamma-alumina, silica-alumina, and mixtures of any two or more thereof. According to the present invention it is particularly preferred that the support material added in step (2) of the inventive method comprises silica and/or gamma-alumina, wherein more preferably the support material is silica, gamma-alumina, or a mixture of silica and gamma-alumina, and more preferably is silica or gamma-alumina.

As regards the chemical and physical properties of the support material which may be provided in step (2) of the method for preparing a catalyst according to the present invention and in particular the chemical and physical properties of the preferred one or more metal oxides and/or metalloid oxides comprised in said support material, no particular restrictions apply such that in principle any conceivable support material and in particular any conceivable metal oxides and/or metalloid oxides may be comprised therein. Thus, by way of example, the BET surface area of the one or more metal oxides and/or metalloid oxides preferably comprised in the support material may range anywhere from 150 to 500 m²/g, wherein it is preferred that the surface area of the one or more metal oxides and/or metalloid oxides ranges from 200 to 450 m²/g, and more preferably from 220 to 410 m²/g, and more preferably from 250 to 380 m²/g. According to the present invention it is particularly preferred that the BET surface area of the one or more metal oxides and/or metalloid oxides is in the range of from 280 to 350 m²/g. According to the present invention, the values for the BET surface area refer to those which are determined according to ISO 9277 or DIN 66131, wherein the values for the BET surface area refer to those obtained according to ISO 9277.

In step (3) of the inventive method, the mixture obtained in step (2) is evaporated to dryness. To this effect, any conceivable method may be employed wherein it is preferred according to the inventive method that evaporation to dryness of the mixture obtained in (2) in step (3) involves heating of the mixture. As regards the temperature to which the mixture obtained in step (2) is preferably heated in step (3) for evaporation to dryness, no particular restrictions apply such that any suitable temperature may be employed to this effect provided that the one or more solvents contained in the mixture obtained in step (2) may be completely removed. Thus, by way of example, evaporation to dryness of the mixture obtained in step (2) may be conducted by heating to a temperature in the range of from 30 to 140° C., wherein according to the method it is preferred that the preferred heating of the mixture in step (2) is conducted at a temperature in the range of from 50 to 130° C., more preferably from 70 to 120° C., and more preferably from 90 to 110° C. According to the inventive method it is particularly preferred that in step (3) the evaporation to dryness of the mixture obtained in step (2) involves heating of the mixture to a temperature in the range of from 95 to 105° C.

As regards step (4) of the inventive method involving heating the mixture obtained in step (3) in a hydrogen containing atmosphere, no particular restrictions apply relative to the temperature which is employed. Thus, by way of example, the temperature of heating in step (4) may be in the range of anywhere from 300 to 1,200° C., wherein it is preferred according to the present invention that the mixture is heated in step (4) to a temperature in the range of from 500 to 1,100° C., more preferably from 600 to 1,000° C., more preferably from 750 to 950° C., and more preferably from 800 to 900° C. According to the present invention it is particularly preferred that heating of the mixture in step (4) is conducted at a temperature in the range of from 825 to 875° C.

Concerning the content of hydrogen in the atmosphere employed for the heating of the mixture obtained in step (3) in step (4), no particular restrictions apply, such that by way of example the atmosphere in step (4) may contain 50 vol.-% or less of hydrogen. In instances wherein the atmosphere employed in step (4) contains one or more additional gases in addition to hydrogen, there is no particular restriction as to said one or more additional gases provided that a ternary intermetallic compound of formula (I) may be obtained according to the inventive method. It is, however, preferred according to the present invention that the one or more further gases contained in the atmosphere employed in step (4) in instances wherein said atmosphere does not consist of hydrogen comprise at least one inert gas wherein preferably the atmosphere according to said particular and preferred embodiments contains an inert gas in addition to hydrogen. As regards the preferred inert gas contained in the atmosphere employed in step (4), no particular restriction applies, neither with respect to the type nor with respect to the number and/or content of the one or more inert gases which may be contained therein in addition to hydrogen. Thus, by way of example, the inert gas may comprise nitrogen and/or one or more noble gases, preferably one or more gases selected from the group consisting of nitrogen, helium, argon, and mixtures of two or more thereof, wherein preferably nitrogen is contained as an inert gas in addition to hydrogen.

According to the present invention it is further preferred that the atmosphere in step (4) contains 30 vol.-% or less of hydrogen in addition to an inert gas, and more preferably 10 vol.-% or less. According to the present invention it is particularly preferred that the atmosphere in step (4) contains 5 vol.-% or less of hydrogen in addition to an inert gas.

As regards the duration of heating in step (4) of the inventive method, no particular restriction applies provided that a ternary intermetallic compound of formula (I) may be obtained in the inventive method. Thus, by way of example, the step of heating the mixture obtained in step (3) in a hydrogen containing atmosphere in step (4) may be performed for a duration of anywhere from 0.5 to 24 h, wherein preferably the step of heating is conducted for a duration of from 1 to 18 h, more preferably from 2 to 12 h, and more preferably from 3 to 8 h. According to the present invention it is particularly preferred that the step of heating the mixture obtained in step (3) in a hydrogen containing atmosphere in step (4) is performed for a duration ranging from 4 to 6 h.

In addition to relating to a catalyst comprising particles of a ternary intermetallic compound of formula (I) supported on a support material according to any of the particular and preferred embodiments as described in the present application, the present invention further relates to a catalyst as obtained and/or obtainable according to any of the particular and preferred embodiments of the inventive method as described in the present application. In particular, the present invention does not only relate to a catalyst comprising particles of a ternary intermetallic compound of formula (I) supported on a support material as may be directly obtained by the inventive method according to any of the particular and preferred embodiments thereof, i.e. the direct product thereof, but also to any catalyst comprising particles of a ternary intermetallic compound of formula (I) supported on a support material as may be obtained, i.e. as is obtainable, according to the inventive method as defined in any of the particular and preferred embodiments thereof irrespective of the actual method according to which the catalyst is obtained, provided that it may be obtained by the inventive method according to any of the particular and preferred embodiments thereof.

Furthermore, the present invention also relates to a process for the condensation of a carbonyl compound with a methylene group containing compound comprising simultaneously contacting a carbonyl compound and a methylene group containing compound with a catalyst according to any of the particular and preferred embodiments as described in the present application.

As regards the carbonyl compound which may be employed in the inventive process, no particular restrictions apply provided that it may react with a methylene compound upon contacting thereof with the catalyst according to the present invention. Thus, by way of example, the carbonyl compound may be selected from the group consisting of aldehydes and ketones, wherein preferably the carbonyl compound is selected from the group consisting of aldehydes, and more preferably from the group consisting of aryl aldehydes. According to the present invention it is particularly preferred that benzaldehyde is employed as the carbonyl compound in the inventive process.

As concerns the methylene group containing compound which is employed in the inventive process, again no particular restrictions apply provided that it may react with a carbonyl compound to form a condensation product upon being contacted with the inventive catalyst. Thus, by way of example, the methylene group containing compound may be selected from the group consisting of active hydrogen compounds which may form carbanions upon reaction with a base, wherein preferably the methylene group containing compound is selected from the group consisting of diphenylmethane, xanthene, C2-C4 alcohols, thioxanthene, aldehydes, ketones, fluorene, indene, cyclopentadiene, malononitrile, acetylacetone, dimedone, and C2-C4 carboxylic acids, including mixtures of two or more thereof, wherein more preferably the methylene group containing compound is selected from the group consisting of diphenylmethane, xanthene, ethanol, propanol, acetaldehyde, propionaldehyde, dimethylketone, methylethyl ketone, diethylketone, cyclopentadiene, malononitrile, acetylacetone, acetic acid, and propionic acid, and mixtures of two or more thereof. According to the inventive process, it is particularly preferred that the methylene group containing compound is selected from the group consisting of propanol, propionaldehyde, methylethyl ketone, cyclopentadiene, malononitrile, acetylacetone, propionic acid, and mixtures of two or more thereof, more preferably from the group consisting ofpropionaldehyde, methylethyl ketone, malononitrile, acetylacetone, and mixtures of two or more thereof, wherein it is yet further preferred that the methylene group containing compound is malononitrile.

As concerns the conditions under which the carbonyl compound is condensed with a methylene group containing compound according to the inventive process, no particular restrictions apply such that any suitable conditions may be employed to this effect provided that a condensation product of the aforementioned compounds is obtained upon contacting thereof with the inventive catalyst. Thus, as regards the temperature at which the carbonyl compound and the methylene group containing compound are brought in to contact with the catalyst, no particular restrictions apply such that any suitable temperature may be employed. Thus, by way of example, the contacting of the carbonyl compound and the methylene group containing compound with the catalyst according to any of the particular and preferred embodiments of the present invention may be performed at a temperature in the range of anywhere from 30 to 150° C., wherein preferably the contacting of the carbonyl compound and the methylene group containing compound with the catalyst is performed at a temperature in the range of from 50 to 120° C., more preferably from 60 to 100° C., and more preferably from 70 to 90° C. According to the present invention it is particularly preferred that the contacting of the carbonyl compound and the methylene group containing compound with the catalyst in the inventive process is performed at a temperature in the range of from 75 to 85° C.

According to the present invention it is preferred that the inventive process for the condensation of a carbonyl compound with a methylene group containing compound is performed in the presence of one or more solvents. As concerns the one or more solvents which may be employed to this effect, no particular restrictions apply provided that a condensation product of the carbonyl compound with the methylene group containing compound may be obtained upon contacting thereof with the inventive catalyst. Thus, by way of example, the one or more solvents in the presence of which the carbonyl compound and the methylene group containing compound are contacted with the catalyst may be selected from the group consisting of non-polar solvents, wherein preferably the one or more solvents are selected from the group consisting of pentane, cyclopentane, hexane, cyclohexane, benzene, toluene, 1,4-dioxane, chloroform, dimethylether, diethylether, dichloromethane, and mixtures of two or more thereof. According to the inventive process it is further preferred that the contacting of the carbonyl compound and the methylene group containing compound with the catalyst is performed in the presence of one or more solvents selected from the group consisting of pentane, cyclopentane, hexane, cyclohexane, benzene, toluene, 1,4-dioxane, diethylether, and mixtures of two or more thereof, and more preferably from the group consisting of pentane, cyclopentane, hexane, cyclohexane, benzene, toluene, and mixtures of two or more thereof. According to the present invention it is particularly preferred that the contacting of the carbonyl compound with the methylene group containing compound with the inventive catalyst in the inventive process is performed in the presence of toluene.

Finally, the present invention relates to the use of a catalyst comprising particles of a ternary intermetallic compound of formula (I) supported on a support material according to any of the particular and preferred embodiments of the present invention as described in the present application including a catalyst as obtained and/or obtainable according to any one of the particular and preferred embodiments of the inventive method as described in the present application. With respect to the inventive use, there is no restriction whatsoever relative to the application in which the aforementioned catalyst may be employed wherein the catalyst may be employed as such and/or as a catalyst support, preferably as such, i.e. as a catalyst in chemical reactions. As regards the reactions in which the inventive catalyst may be employed, no particular restrictions apply such that in principle it may be used as a catalyst in any conceivable chemical reaction provided that it may reduce the activation energy for accelerating the reaction rate compared to the uncatalyzed chemical reaction. It is, however, preferred according to the present invention that the inventive catalyst according to any of the particular and preferred embodiments described in the present application is used as a catalyst for the condensation of a carbonyl compound with a methylene group containing compound or is used for the selective catalytic reduction of nitrogen oxides in exhaust gas. According to the present invention it is particularly preferred that the inventive catalyst according to any of the particular and preferred embodiments is employed as a catalyst for a Knoevenagel condensation reaction.

The present invention is further characterized by the following particular and preferred embodiments, including the combinations of the embodiments indicated by the respective dependencies:
1. A catalyst comprising particles of a ternary intermetallic compound of the following formula (I):

X₂YZ (I)
wherein X, Y, and Z are different from one another;
X being selected from the group consisting of Mn, Fe, Co, Ni, Cu, and Pd;
Y being selected from the group consisting of V, Mn, Cu, Ti, and Fe; and
Z being selected from the group consisting of Al, Si, Ga, Ge, In, Sn, and Sb;
wherein the particles of the ternary intermetallic compound are supported on a support material.
2. The catalyst of embodiment 1, wherein X is selected from the group consisting of Mn, Fe, Co, Ni, and Cu, preferably from the group consisting of Fe, Co, Ni, and Cu, more preferably from the group consisting of Fe, Co, Cu, wherein more preferably X is Co and/or Cu, preferably Cu.
3. The catalyst of embodiment 1 or 2, wherein Y is selected from the group consisting of Cu, Mn, Fe, and Ti, wherein more preferably Y is Mn and/or Fe, preferably Fe.
4. The catalyst of any of embodiments 1 to 3, wherein Z is selected from the group consisting of Al, Si, Ga, Ge, In, Sn, and Sb, preferably from the group consisting of Al, Si, Ga, and In, more preferably from the group consisting of Al, Si, and Ga, wherein more preferably Z is Al and/or Si, preferably Al.
5. The catalyst of any of embodiments 1 to 4, wherein the ternary intermetallic compound is selected from the group consisting of Co₂FeAl, Co₂FeSi, Co₂FeGa, Co₂FeIn, Cu₂FeAl, Cu₂FeSi, Fe₂MnGa, Fe₂MnSi, Co₂CuAl, Fe₂TiGa, and mixtures of two or more thereof, preferably selected from the group consisting of Co₂FeAl, Co₂FeSi, Cu₂FeAl, Cu₂FeSi, Co₂CuAl, Fe₂MnSi, and mixtures of two or more thereof, more preferably selected from the group consisting of Cu₂FeAl, Cu₂FeSi, Co₂CuAl, Fe₂MnSi, and mixtures of two or more thereof, wherein more preferably the ternary intermetallic compound comprises Cu₂FeAl and/or Cu₂FeSi, preferably Cu₂FeAl, wherein more preferably the ternary intermetallic compound is Cu₂FeAl and/or Cu₂FeSi, preferably Cu₂FeAl.
6. The catalyst of any of embodiments 1 to 5, wherein the intermetallic compound is a Heusler phase.
7. The catalyst of any of embodiments 1 to 6, wherein the average particle size D50 of the ternary intermetallic compound particles is in the range of from 3 nm to 2 μm, preferably in the range of from 5 nm to 1.5 μm, more preferably in the range of 10 nm to 1 μm, more preferably in the range of 20 nm to 700 nm, more preferably in the range of 30 nm to 500 nm, more preferably in the range of 40 nm to 300 nm, more preferably in the range of 50 nm to 200 nm, more preferably in the range of 60 nm to 150 nm, more preferably in the range of 70 nm to 120 nm, more preferably in the range of 80 nm to 100 nm, and more preferably in the range of 85 nm to 90 nm.
8. The catalyst of any of embodiments 1 to 7, wherein the support material comprises one or more metal oxides and/or metalloid oxides selected from the group consisting of silica, alumina, silica-alumina, titania, zirconia, and mixtures of two or more thereof, preferably from the group consisting of silica, gamma-alumina, silica-alumina, and mixtures of two or more thereof, wherein more preferably the support material comprises silica and/or gamma-alumina, wherein more preferably the support material is silica, gamma-alumina, or a mixture of silica and gamma-alumina, more preferably silica or gamma-alumina.
9. The catalyst of embodiment 8, wherein the BET surface area of the one or more metal oxides and/or metalloid oxides comprised in the support material ranges from 150 to 500 m²/g, preferably from 200 to 450 m²/g, more preferably from 220 to 410 m²/g, more preferably from 250 to 380 m²/g, and more preferably from 280 to 350 m²/g, wherein the BET surface area is determined according to ISO 9277 or DIN 66131, preferably according to ISO 9277.
10. The catalyst of embodiment 8 or 9, wherein the weight ratio of the ternary intermetallic compound X₂YZ to the one or more metal oxides and/or metalloid oxides comprised in the support material ranges from 0.5:99.5 to 50:50, preferably from 1:99 to 30:70, more preferably from 3:97 to 20:80, more preferably from 5:95 to 15:85, more preferably from 6:94 to 12:88, more preferably from 7:93 to 11:89, and more preferably from 8:92 to 10:90.
11. Method for the preparation of a catalyst containing a ternary intermetallic compound of the following formula (I):

X₂YZ (I)
wherein X, Y, and Z are different from one another, comprising:
(1) providing a solution containing one or more precursor compounds for X, one or more precursor compounds for Y, one or more precursor compounds for Z, and one or more solvents;
(2) adding a support material to the solution provided in (1);
(3) evaporating the mixture obtained in (2) to dryness; and
(4) heating the mixture obtained in (3) in a hydrogen containing atmosphere,
wherein X is selected from the group consisting of Mn, Fe, Co, Ni, Cu, and Pd;
Y is selected from the group consisting of V, Mn, Cu, Ti, and Fe; and
Z is selected from the group consisting of Al, Si, Ga, Ge, In, Sn, and Sb.
12. The method of embodiment 11, wherein X is selected from the group consisting of Mn, Fe, Co, Ni, and Cu, preferably from the group consisting of Fe, Co, Ni, and Cu, more preferably from the group consisting of Fe, Co, Cu, wherein more preferably X is Co and/or Cu, preferably Cu.
13. The method of embodiment 11 or 12, wherein Y is selected from the group consisting of Cu, Mn, Fe, and Ti, wherein more preferably Y is Mn and/or Fe, preferably Fe.
14. The method of any of embodiments 11 to 13, wherein Z is selected from the group consisting of Al, Si, Ga, Ge, In, Sn, and Sb, preferably from the group consisting of Al, Si, Ga, and In, more preferably from the group consisting of Al, Si, and Ga, wherein more preferably Z is Al and/or Si, preferably Al.
15. The method of any of embodiments 11 to 14, wherein the one or more precursor compounds for X are selected from the group consisting of salts of X, wherein preferably the salts of X are selected from the group consisting of acetates, acetylacetonates, nitrates, nitrites, sulfates, hydrogensulfates, dihydrogensulfates, sulfites, hydrogensulfites, phosphates, hydrogenphosphates, dihydrogenphosphates, halides, cyanides, cyanates, isocyanates, and mixtures of two or more thereof, more preferably from the group consisting of acetates, acetylacetonates, nitrates, chlorides, bromides, fluorides, and mixtures of two or more thereof, wherein more preferably one or more acetates, acetylacetonates, nitrates and/or chlorides are employed as the one or more precursor compounds of X.
16. The method of any of embodiments 11 to 15, wherein the one or more precursor compounds for Y are selected from the group consisting of salts of Y, wherein preferably the salts of Y are selected from the group consisting of acetates, acetylacetonates, nitrates, nitrites, sulfates, hydrogensulfates, di hydrogensulfates, sulfites, hydrogensulfites, phosphates, hydrogenphosphates, dihydrogenphosphates, halides, cyanides, cyanates, isocyanates, and mixtures of two or more thereof, more preferably from the group consisting of acetates, acetylacetonates, nitrates, chlorides, bromides, fluorides, and mixtures of two or more thereof, wherein more preferably one or more acetates, acetylacetonates, and/or nitrates are employed as the one or more precursor compounds of Y.
17. The method of any of embodiments 11 to 16, wherein the one or more precursor compounds for Z are selected from the group consisting of salts of Z, wherein preferably the salts of Z are selected from the group consisting of C1-C4 alkoxides, acetates, nitrates, nitrites, sulfates, hydrogensulfates, dihydrogensulfates, sulfites, hydrogensulfites, phosphates, hydrogenphosphates, dihydrogenphosphates, halides, cyanides, cyanates, isocyanates, and mixtures of two or more thereof, more preferably from the group consisting of C2-C3 alkoxides, acetates, nitrates, chlorides, bromides, fluorides, and mixtures of two or more thereof, wherein more preferably from the group consisting of ethoxides, acetates, nitrates, chlorides, and mixtures of two or more thereof.
18. The method of any of embodiments 11 to 17, wherein the one or more solvents are selected from the group consisting of polar solvents, preferably from the group consisting of polar protic solvents, more preferably from the group consisting of water, C1-C4 alcohols, and mixtures of two or more thereof, more preferably from the group consisting of water, C1-C3 alcohols, and mixtures of two or more thereof, more preferably from the group consisting of water, methanol, ethanol, and mixtures of two or three thereof, wherein more preferably the one or more solvents comprise water and/or methanol, preferably water, wherein more preferably distilled water is employed as the one or more solvents.
19. The method of any of embodiments 11 to 18, wherein the support material comprises one or more metal oxides and/or metalloid oxides selected from the group consisting of silica, alumina, silica-alumina, titania, zirconia, and mixtures of two or more thereof, preferably from the group consisting of silica, gamma-alumina, silica-alumina, and mixtures of two or more thereof, wherein more preferably the support material comprises silica and/or gamma-alumina, wherein more preferably the support material is silica, gamma-alumina, or a mixture of silica and gamma-alumina, more preferably silica or gamma-alumina.
20. The method of embodiment 19, wherein the BET surface area of the one or more metal oxides and/or metalloid oxides ranges from 150 to 500 m²/g, preferably from 200 to 450 m²/g, more preferably from 220 to 410 m²/g, more preferably from 250 to 380 m²/g, and more preferably from 280 to 350 m²/g, wherein the BET surface area is determined according to ISO 9277 or DIN 66131, preferably according to ISO 9277.
21. The method of any of embodiments 11 to 20, wherein in (3) the evaporation to dryness of the mixture obtained in (2) involves heating of the mixture, wherein the mixture is preferably heated to a temperature in the range of from 30 to 140° C., more preferably from 50 to 130° C., more preferably from 70 to 120° C., more preferably from 90 to 110° C., and more preferably from 95 to 105° C.
22. The method of any of embodiments 11 to 21, wherein in (4) the mixture is heated to a temperature ranging from 300 to 1,200° C., more preferably from 500 to 1,100° C., more preferably from 600 to 1,000° C., more preferably from 750 to 950° C., more preferably from 800 to 900° C., and more preferably from 825 to 875° C.
23. The method of any of embodiments 11 to 22, wherein the atmosphere in (4) contains 50 vol.-% or less of hydrogen in addition to an inert gas, preferably 30 vol.-% or less of hydrogen, more preferably 10 vol.-% or less, and more preferably 5 vol.-% or less of hydrogen in (4).
24. The method of any of embodiments 11 to 23, wherein the step of heating the mixture obtained in (3) in a hydrogen containing atmosphere in (4) is performed for a duration of from 0.5 to 24 h, more preferably from 1 to 18 h, more preferably from 2 to 12 h, more preferably from 3 to 8 h, and more preferably from 4 to 6 h.
25. A catalyst obtained and/or obtainable according to the process of any of embodiments 11 to 24.
26. A process for the condensation of a carbonyl compound with a methylene group containing compound comprising simultaneously contacting a carbonyl compound and a methylene group containing compound with a catalyst according to any of embodiments 1 to 10 and 25.
27. The process of embodiment 26, wherein the carbonyl compound is selected from the group consisting of aldehydes and ketones, preferably from the group consisting of aldehydes, more preferably from the group consisting of aryl aldehydes, wherein more preferably benzaldehyde is employed as the carbonyl compound.
28. The process of embodiment 26 or 27, wherein the methylene group containing compound is selected from the group consisting of active hydrogen compounds which may form carbanions upon reaction with a base, wherein preferably the methylene group containing compound is selected from the group consisting of diphenylmethane, xanthene, C2-C4 alcohols, thioxanthene, aldehydes, ketones, fluorene, indene, cyclopentadiene, malononitrile, acetylacetone, dimedone, C2-C4 carboxylic acids, and mixtures of two or more thereof, more preferably from the group consisting of diphenylmethane, xanthene, ethanol, propanol, acetaldehyde, propionaldehyde, dimethylketone, methylethyl ketone, diethylketone, cyclopentadiene, malononitrile, acetylacetone, acetic acid, and propionic acid, more preferably from the group consisting of propanol, propionaldehyde, methylethyl ketone, cyclopentadiene, malononitrile, acetylacetone, propionic acid, and mixtures of two or more thereof, more preferably from the group consisting ofpropionaldehyde, methylethyl ketone, malononitrile, acetylacetone, and mixtures of two or more thereof, wherein more preferably the methylene group containing compound is malononitrile.
29. The process of any of embodiments 26 to 28, wherein the contacting of the carbonyl compound and the methylene group containing compound with the catalyst is performed at a temperature in the range of from 30 to 150° C., preferably from 50 to 120° C., more preferably from 60 to 100° C., more preferably from 70 to 90° C., and more preferably from 75 to 85° C.
30. The process of any of embodiments 26 to 29, wherein the contacting of the carbonyl compound and the methylene group containing compound with the catalyst is performed in the presence of one or more solvents, wherein the one or more solvents are preferably selected from the group consisting of non-polar solvents, more preferably from the group consisting of pentane, cyclopentane, hexane, cyclohexane, benzene, toluene, 1,4-dioxane, chloroform, dimethylether, diethylether, dichloromethane, and mixtures of two or more thereof, more preferably from the group consisting of pentane, cyclopentane, hexane, cyclohexane, benzene, toluene, 1,4-dioxane, diethylether, and mixtures of two or more thereof, more preferably from the group consisting of pentane, cyclopentane, hexane, cyclohexane, benzene, toluene, and mixtures of two or more thereof, wherein more preferably the contacting of the carbonyl compound and the methylene group containing compound with the catalyst is performed in the presence of toluene.
31. Use of a catalyst according to any of embodiments 1 to 10 and 25 as a catalyst and/or catalyst support, preferably as a catalyst, and more preferably as a catalyst for the condensation of a carbonyl compound with a methylene group containing compound or for the selective catalytic reduction of nitrogen oxides in exhaust gas, and more preferably as a catalyst for a Knoevenagel condensation reaction.

### DESCRIPTION OF THE FIGURES

FIGS. 1a to 14a, and 15 to 17 show the X-Ray Diffraction (XRD) pattern of the catalyst sample obtained from Examples 1-17, respectively. In the figures, the diffraction angle 2 theta in ° is shown along the abscissa and the intensities are plotted along the ordinate.

FIG. 14b displays the XRD pattern of gamma-alumina, wherein the diffraction angle 2 theta in ° is shown along the abscissa and the intensities are plotted along the ordinate.

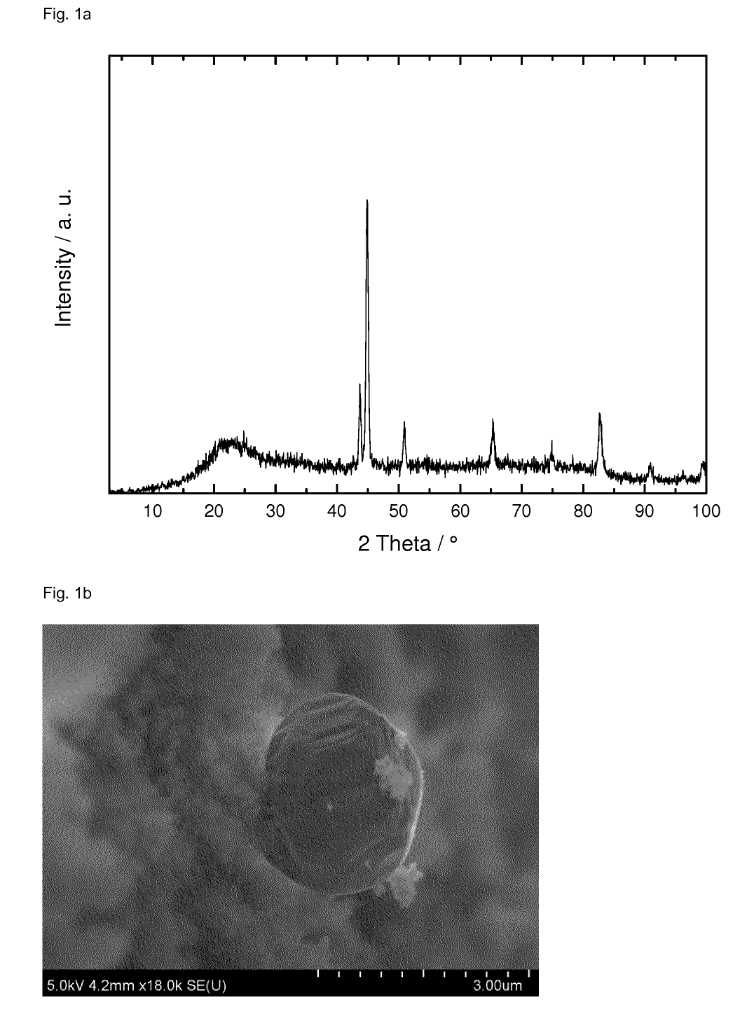

FIGS. 1b to 13b show the scanning electron micrograph (SEM) of particles of the ternary intermetallic compound contained in the catalyst samples obtained from Examples 1-13, respectively.

FIG. 18 shows the results from catalyst testing performed on the catalyst samples from Examples 1-3 in the Knoevenagel condensation reaction of benzaldehyde with malononitrile to benzylidenemalononitrile (BMDN). In the Figure, the yield of BMDN in % is shown along the ordinate and the reaction time in hours is plotted along the abscissa. The results for Example 1 are indicated with the symbol “♦”, those for Example 2 with the symbol “●”, and those for Example 3 with the symbol “ [symbol] ”. The results from testing using the support material (SiO₂) by itself are indicated with the symbol “∘”, and those from the control experiment conducted in the absence of a catalyst are indicated by the symbol “▴”.

FIGS. 19 and 20 respectively show the results from catalyst testing performed on the catalyst samples from Examples 4-7 in the Knoevenagel condensation reaction of benzaldehyde with malononitrile to benzylidenemalononitrile (BMDN). In the figures, the yield of BMDN in % is shown along the ordinate and the reaction time in hours is plotted along the abscissa. The results for Example 4 are indicated with the symbol “★”, those for Example 5 with the symbol “♦”, those for Example 6 with the symbol “●”, and those for Example 7 with the symbol “ [symbol] ”. The results from testing using the support material (SiO₂) by itself are indicated with the symbol “∘”, and those from the control experiment conducted in the absence of a catalyst are indicated by the symbol “▴”.

FIGS. 21 and 22 respectively show the results from catalyst testing performed in Example 18 as performed on the catalyst samples from Examples 8-10 in the Knoevenagel condensation reaction of benzaldehyde with malononitrile to benzylidenemalononitrile (BMDN). In the Figure, the yield of BMDN in % is shown along the ordinate and the reaction time in hours is plotted along the abscissa. The results for Example 8 are indicated with the symbol “♦”, those for Example 9 with the symbol “●”, and those for Example 10 with the symbol “ [symbol] ”. The results from testing using the support material (SiO₂) by itself are indicated with the symbol “0”, and those from the control experiment conducted in the absence of a catalyst are indicated by the symbol “▴”.

FIGS. 23 to 28 respectively show the results from selective catalytic reduction (SCR) testing performed in Example 19 as performed on the catalyst samples from Examples 12-17 wherein the values for the conversion of NOₓ is displayed by the symbol “●” and those for the yield of N₂O is displayed by the symbol “▪”, wherein the conversion rate/yield in % are shown along the ordinate and the reaction temperature in ° C. is plotted along the abscissa. In the respective figure, the results from SCR testing performed with the fresh catalyst samples are displayed on the left, those from testing performed on the catalyst samples aged at 750° C. for 5 hours are displayed in the middle, and those from testing performed on the catalyst samples aged at 850° C. for 6 hours are displayed on the right, respectively.

FIGS. 29 to 35 display High Angle Annular Dark Field-Scanning Transmission Electron Microscopy (HAADF-STEM) images obtained for the sample from Example 8. In the images, selected examples of individual ternary intermetallic compound particles of the Heusler phase Co₂FeGa are indicated by arrows.

FIGS. 36 to 38 display Scanning Electron Microscopy images obtained with detection of backscattered electrons (SEM-BSE). In FIG. 36, selected examples of individual ternary intermetallic compound particles of the Heusler phase Co₂FeGa are indicated by arrows.

FIG. 39 displays the particle size distribution for the particles mainly having a particle diameter of less than 400 nm as obtained from the HAADF-STEM images in FIGS. 29 to 35. The minimum diameter of the particles in nm is shown along the abscissa and the relative number of the particles having a given minimum diameter is plotted along the ordinate.

FIG. 40 displays the particle size distribution for the particles mainly having a particle diameter of 400 nm or greater as obtained from the SEM-BSE images in FIGS. 36 to 38. The minimum diameter of the particles in μm is shown along the abscissa and the relative number of the particles having a given minimum diameter is plotted along the ordinate.

### EXPERIMENTAL SECTION

The structure of the samples was characterized by powder x-ray diffraction (XRD) using Cu K-alpha radiation at 40 kV and 30 mA (Siemens D5005) at room temperature. The measurement of the powder patterns of the catalysts was carried out in the range of 3≤2θ≤100° with a step size of 0.05°.

The BET surface areas of the Heusler compounds were analyzed by nitrogen physisorption at 77 K with a Quantachrome AUTOSORB-1. The samples were pre-activated for 12 hours at 200° C. (Examples 1-10) or 100° C. (Examples 11 and 12). The BET surface area of pure γ-Al₂O₃ (Fa. Sasol Puralox SCFa-230) is 230 m²·g⁻¹. The BET surface area of the metal-loaded materials decreases to 170-180 m²·g⁻¹.

Scanning electron microscopy (SEM, SU 8000 Hitachi) was used to study the size and surface morphology of nanoparticles. The materials were coated with 5 nm chromium layer and measured at a voltage of 5 kV (Examples 1-10) or 20 kV (Examples 11 and 12).

Particle Size Analysis

The particle size D50 of the ternary intermetallic compound particles was determined by a combination of High Angle Annular Dark Field-Scanning Transmission Electron Microscopy (HAADF-STEM) and Scanning Electron Microscopy with detection of backscattered electrons (SEM-BSE) at 20 kV.

For conducting the HAADF-STEM analysis, samples were dispersed in ethanol. In view of the bimodal distribution of particle sizes for the ternary intermetallic compound particles in the inventive samples which may be divided into particles with a particle diameter of less than 400 nm and particles with a particle diameter of 400 nm or greater, the particle diameters of particles having a particle diameter of less than 400 nm was analyzed by HAADF-STEM, whereas the particle diameters of the particles having a particle diameter of 400 nm or greater was analyzed by SEM-BSE.

For determining the average particle diameter D50, multiple HAADF-STEM and SEM-BSE images were prepared and the particles in the images manually analyzed by a technical expert. For statistical analysis, a total of 10-20 HAADF-STEM and SEM-BSE images were prepared and evaluated. The respective images of the samples were enlarged such that the smallest particle dimensions were represented by at least 10 pixels. Individual particles identified in the images were then measured and their minimum diameter respectively recorded in accordance with Recommendation 2011/696/EU of the European Commission. Agglomerates of particles were treated as particles, i.e. the minimum diameter of the agglomerate was recorded. In the case of irregularly shaped particles or agglomerates, the minimum Feret diameter was determined.

The results from the analysis of the respective HAADF-STEM and SEM-BSE images was then respectively compiled and the D50 value for the average diameter calculated for the range of particle diameters from 0 nm to <400 nm and from 400 nm to 7 μm.

### Example 1: Co₂FeGa on SiO₂ (“Co₂FeGa@SiO₂”)

Methanol (500 ml) was supplied to CoCl₂.6H₂O (2.57 g, 10.8 mmol), Fe(NO₃)₃.9H₂O (1.62 g, 4.0 mmol) and Ga(NO₃)₃.xH₂O (1.21 g, 3.2 mmol). The round bottom flask containing the solution was placed in an ultrasonic bath and treated for 5 minutes. Fumed silica (10.00 g, primary particle average particle size=14 nm) was added to the precursor solution and the suspension was sonicated for 2 h at the room temperature. Then, the methanol from the orange suspension was removed on a rotary evaporator. Water bath temperature was adjusted to 40° C. The orange residue was transferred to a crystallizing dish and dried at 100° C. for 12 hours. The sand-colored solid was cooled to room temperature and grounded to a powder. A part of this powder was distributed in three ceramic shells and placed in a horizontally arranged quartz glass tube reactor mounted in a heating furnace. First, the reactor was rinsed thoroughly with nitrogen (36 ml·min⁻¹) for 10 minutes at room temperature. The annealing was carried out in a hydrogen atmosphere with a flow rate of 50 ml·min⁻¹. The metal-loaded silica was heated within 75 min to 850° C. and this temperature was maintained constant for 5 h. Finally, the gray samples were cooled to room temperature and characterized.

The crystal structure of the Heusler-compounds was determined by X-ray powder diffraction. The X-ray diffraction pattern of Co₂FeGa on SiO₂ for the angle range 2θ=3-100° is shown in FIG. 1a. The sharp reflections between 2θ=40-100° are caused by crystalline nanoparticles, and display the crystalline structure of the Heusler compound. Based on the results of simulation calculations, an assignment of the experimentally observed reflections could be made. The reflexes indicate an ordered superstructure. However, because of the strong noise and the small intensity in the range 2θ=10-40° the characteristic signals for the L2₁ phase may not observed.

FIG. 1b displays a particle of Co₂FeGa on SiO₂ as obtained from scanning electron microscopy of the sample from Example 1.

### Example 2: Co₂FeAl on SiO₂ (“Co₂FeAl@SiO₂”)

Methanol (250 ml) was supplied to CoCl₂.6H₂O (1.28 g, 5.4 mmol), Fe(NO₃)₃.9H₂O (0.81 g, 2.0 mmol) and AlCl₃.6H₂O (0.39 g, 1.6 mmol). The round bottom flask containing the solution was placed in an ultrasonic bath and treated for 5 minutes. Fumed silica (5.03 g, primary particle average particle size=14 nm) was added to the precursor solution and the suspension was sonicated for 2 h at the room temperature. Then, the methanol from the orange suspension was removed on a rotary evaporator. Water bath temperature was adjusted to 40° C. The orange residue was transferred to a crystallizing dish and dried at 100° C. for 12 hours. The sand-colored solid was cooled to room temperature and grounded to a powder. A part of this powder was distributed in three ceramic shells and placed in a horizontally arranged quartz glass tube reactor mounted in a heating furnace. First, the reactor was rinsed thoroughly with nitrogen (36 ml·min⁻¹) for 10 minutes at room temperature. The annealing was carried out in a hydrogen atmosphere with a flow rate of 50 ml·min⁻¹. The metal-loaded silica was heated within 75 min to 850° C. and this temperature was maintained constant for 5 h. Finally, the gray samples were cooled to room temperature and characterized.

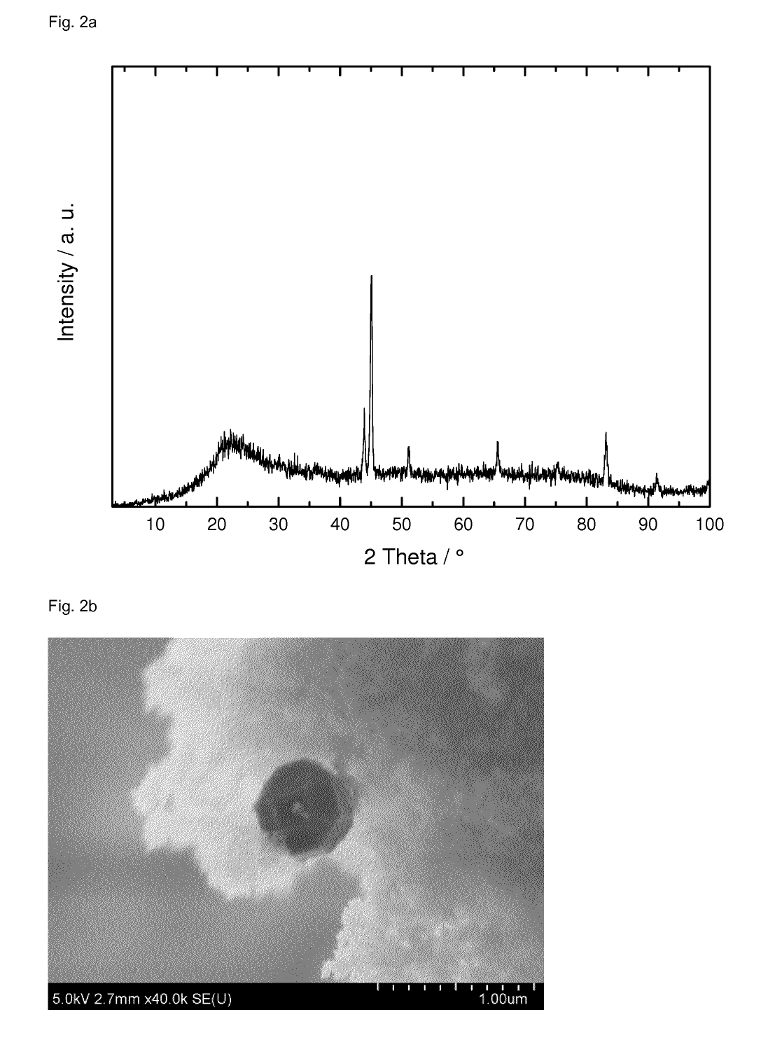

The X-ray diffraction pattern of Co₂FeAl on SiO₂ for the angle range 2θ=3-100° is shown in FIG. 2a. The sharp reflections between 2θ=40-100° are caused by crystalline nanoparticles, and display the crystalline structure of the Heusler compound.

FIG. 2b displays a particle of Co₂FeAl on SiO₂ as obtained from scanning electron microscopy of the sample from Example 2.

### Example 3: Co₂FeSi on SiO₂ (“Co₂FeSi@SiO₂”)

Methanol (250 ml) was supplied to CoCl₂.6H₂O (1.29 g, 5.4 mmol), Fe(NO₃)₃.9H₂O (0.81 g, 2.0 mmol) and TEOS (tetraethyl orthosilicate) (0.33 g, 1.6 mmol). The round bottom flask containing the solution was placed in an ultrasonic bath and treated for 5 minutes. Fumed silica (5.02 g, primary particle average particle size=14 nm) was added to the precursor solution and the suspension was sonicated for 2 h at the room temperature. Then, the methanol from the orange suspension was removed on a rotary evaporator. Water bath temperature was adjusted to 40° C. The orange residue was transferred to a crystallizing dish and dried at 100° C. for 12 hours. The sand-colored solid was cooled to room temperature and grounded to a powder. A part of this powder was distributed in three ceramic shells and placed in a horizontally arranged quartz glass tube reactor mounted in a heating furnace. First, the reactor was rinsed thoroughly with nitrogen (36 ml·min⁻¹) for 10 minutes at room temperature. The annealing was carried out in a hydrogen atmosphere with a flow rate of 50 ml·min⁻¹. The metal-loaded silica was heated within 75 min to 850° C. and this temperature was maintained constant for 5 h. Finally, the gray samples were cooled to room temperature and characterized.

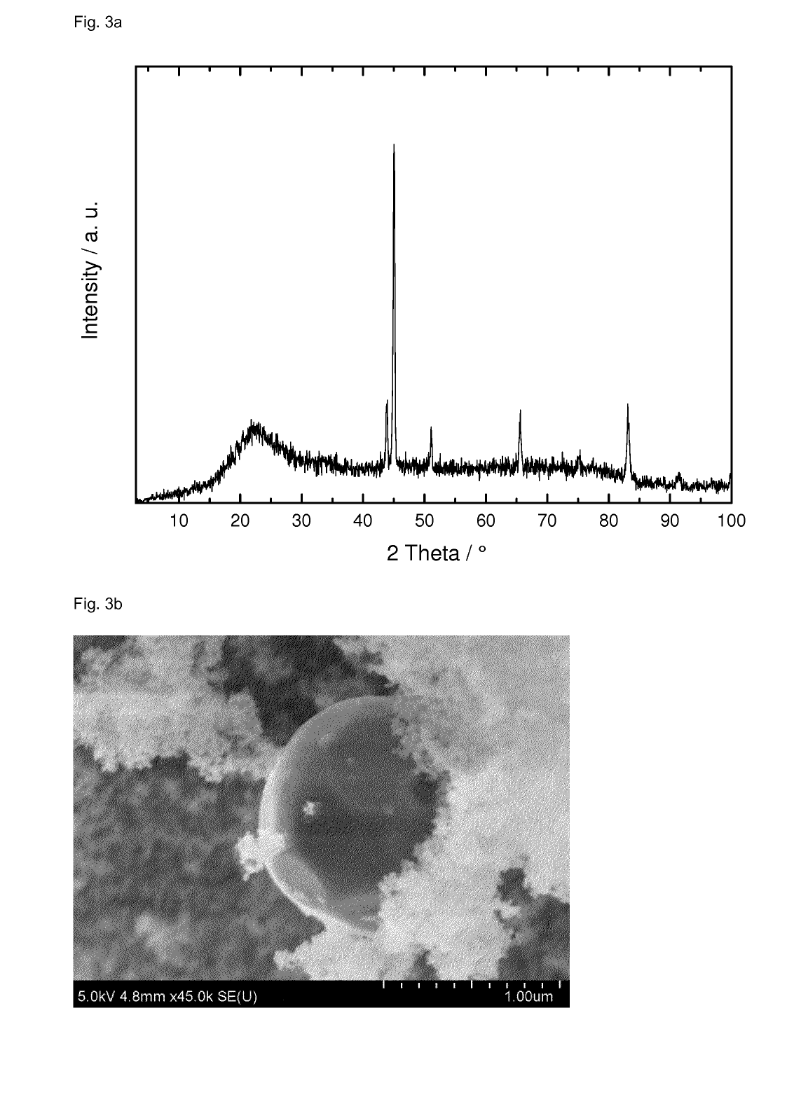

The X-ray diffraction pattern of Co₂FeSi on SiO₂ for the angle range 2θ=3-100° is shown in FIG. 3a. The sharp reflections between 2θ=40-100° are caused by crystalline nanoparticles, and display the crystalline structure of the Heusler compound.

FIG. 3b displays a particle of Co₂FeSi on SiO₂ as obtained from scanning electron microscopy of the sample from Example 3.

### Example 4: Co₂FeIn on SiO₂ (“Co₂FeIn@SiO₂”)

Methanol (250 ml) was supplied to CoCl₂.6H₂O (1.29 g, 5.4 mmol), Fe(NO₃)₃.9H₂O (0.81 g, 2.0 mmol) and InCl₃.xH₂O (0.38 g, 1.6 mmol). The round bottom flask containing the solution was placed in an ultrasonic bath and treated for 5 minutes. Fumed silica (5.04 g, primary particle average particle size=7 nm) was added to the precursor solution and the suspension was sonicated for 2 h at the room temperature. Then, the methanol from the orange suspension was removed on a rotary evaporator. Water bath temperature was adjusted to 40° C. The orange residue was transferred to a crystallizing dish and dried at 100° C. for 12 hours. The sand-colored solid was cooled to room temperature and grounded to a powder. A part of this powder was distributed in three ceramic shells and placed in a horizontally arranged quartz glass tube reactor mounted in a heating furnace. First, the reactor was rinsed thoroughly with nitrogen (36 ml·min⁻¹) for 10 minutes at room temperature. The annealing was carried out in a hydrogen atmosphere with a flow rate of 50 ml·min⁻¹. The metal-loaded silica was heated within 75 min to 850° C. and this temperature was maintained constant for 5 h. Finally, the gray samples were cooled to room temperature and characterized.

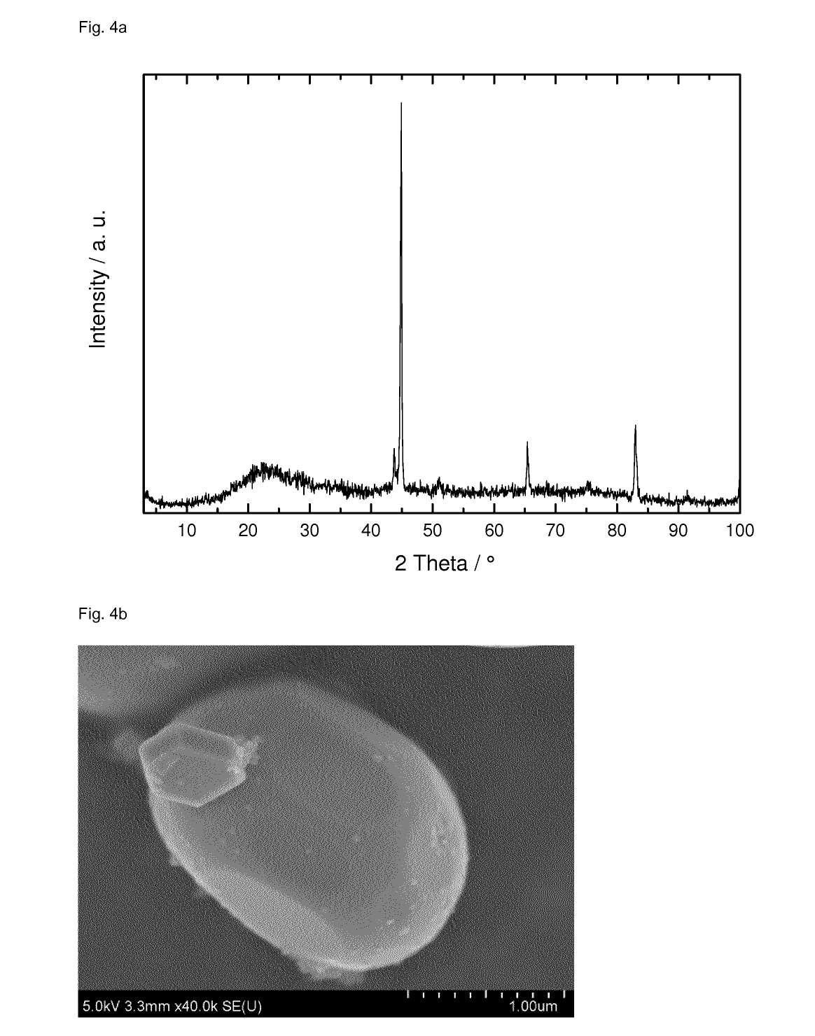

The X-ray diffraction pattern of Co₂FeIn on SiO₂ for the angle range 2θ=3-100° is shown in FIG. 4a. The sharp reflections between 2θ=40-100° are caused by crystalline nanoparticles, and display the crystalline structure of the Heusler compound.

FIG. 4b displays a particle of Co₂FeIn on SiO₂ as obtained from scanning electron microscopy of the sample from Example 4.

### Example 5: Co₂FeGa on SiO₂ (“Co₂FeGa@SiO₂”)

In a typical example, distilled water (500 ml) was supplied to CoCl₂.6H₂O (2.57 g, 10.8 mmol), Fe(NO₃)₃.9H₂O (1.62 g, 4.0 mmol) and Ga(NO₃)₃.xH₂O (1.21 g, 3.2 mmol). The round bottom flask containing the solution was placed in an ultrasonic bath and treated for 5 minutes. Fumed silica (10.02 g, primary particle average particle size=7 nm) was added to the precursor solution and the suspension was sonicated for 2 h at the room temperature. Then, the water from the orange suspension was removed on a rotary evaporator. Water bath temperature was adjusted to 60° C. The orange residue was transferred to a crystallizing dish and dried at 100° C. for 12 hours. The sand-colored solid was cooled to room temperature and grounded to a powder. A part of this powder was distributed in three ceramic shells and placed in a horizontally arranged quartz glass tube reactor mounted in a heating furnace. First, the reactor was rinsed thoroughly with nitrogen (36 ml·min⁻¹) for 10 minutes at room temperature. The annealing was carried out in a hydrogen atmosphere with a flow rate of 50 ml·min⁻¹. The metal-loaded silica was heated within 75 min to 850° C. and this temperature was maintained constant for 5 h. Finally, the gray samples were cooled to room temperature and characterized.

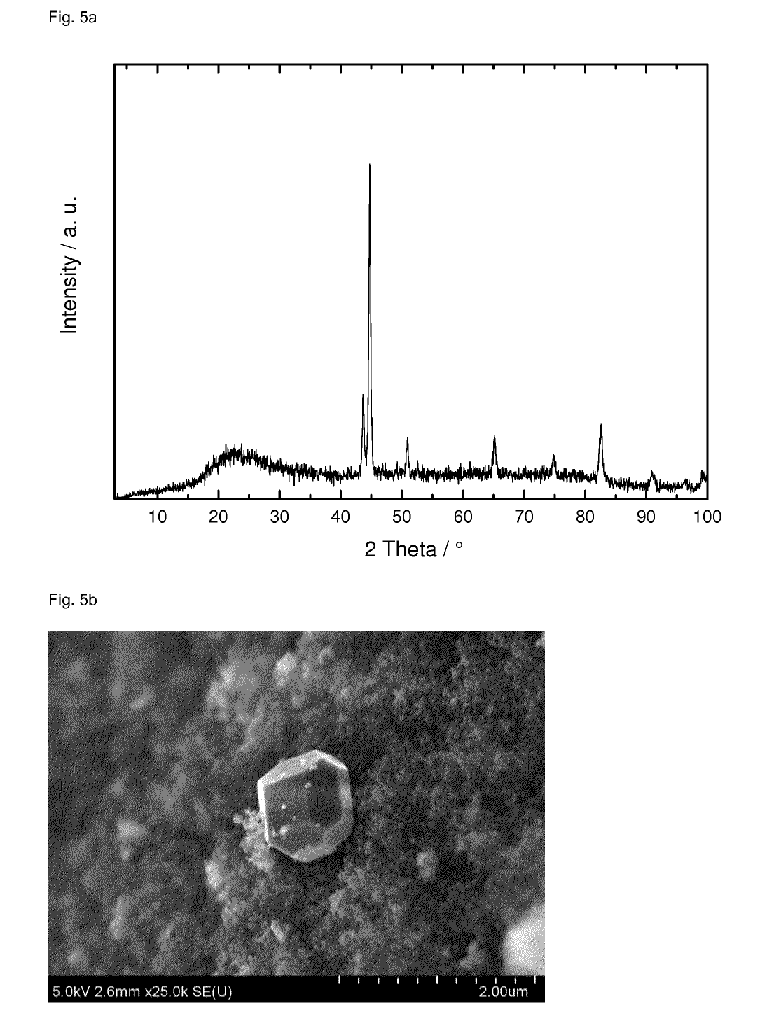

The X-ray diffraction pattern of Co₂FeGa on SiO₂ for the angle range 2θ=3-100° is shown in FIG. 5a. The sharp reflections between 2θ=40-100° are caused by crystalline nanoparticles, and display the crystalline structure of the Heusler compound.

FIG. 5b displays a particle of Co₂FeGa on SiO₂ as obtained from scanning electron microscopy of the sample from Example 5.

### Example 6: Co₂FeAl on SiO₂ (“Co₂FeAl@SiO₂”)

Distilled water (500 ml) was supplied to CoCl₂.6H₂O (2.57 g, 10.8 mmol), Fe(NO₃)₃.9H₂O (1.62 g, 4.0 mmol) and AlCl₃.6H₂O (0.77 g, 3.2 mmol). The round bottom flask containing the solution was placed in an ultrasonic bath and treated for 5 minutes. Fumed silica (10.07 g, primary particle average particle size=7 nm) was added to the precursor solution and the suspension was sonicated for 2 h at the room temperature. Then, the water from the pink suspension was removed on a rotary evaporator. Meanwhile, the color of the suspension has changed from pink to orange. Water bath temperature was adjusted to 60° C. The orange residue was transferred to a crystallizing dish and dried at 100° C. for 12 hours. The sand-colored solid was cooled to room temperature and grounded to a powder. A part of this powder was distributed in three ceramic shells and placed in a horizontally arranged quartz glass tube reactor mounted in a heating furnace. First, the reactor was rinsed thoroughly with nitrogen (36 ml·min⁻¹) for 10 minutes at room temperature. The annealing was carried out in a hydrogen atmosphere with a flow rate of 50 ml·min⁻¹. The metal-loaded silica was heated within 75 min to 850° C. and this temperature was maintained constant for 5 h. Finally, the gray samples were cooled to room temperature and characterized.

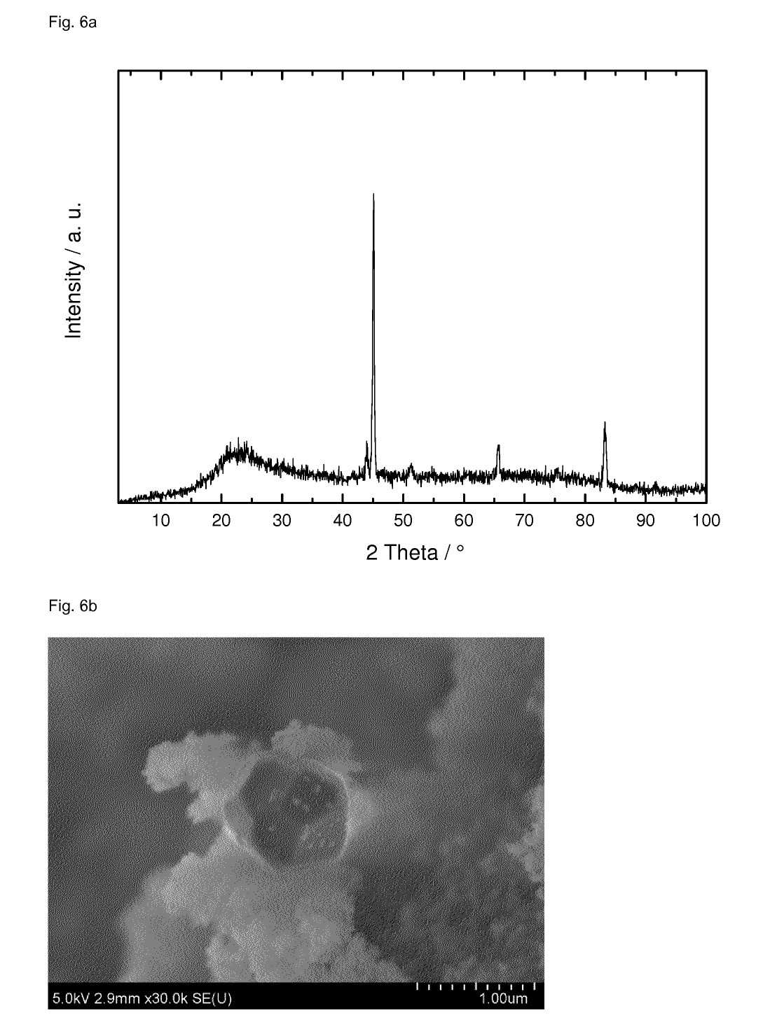

The X-ray diffraction pattern of Co₂FeAl on SiO₂ for the angle range 2θ=3-100° is shown in FIG. 6a. The sharp reflections between 2θ=40-100° are caused by crystalline nanoparticles, and display the crystalline structure of the Heusler compound.

FIG. 6b displays a particle of Co₂FeAl on SiO₂ as obtained from scanning electron microscopy of the sample from Example 6.

### Example 7: Co₂FeSi on SiO₂ (“Co₂FeSi@SiO₂”)

Distilled water (500 ml) was supplied to CoCl₂.6H₂O (2.57 g, 10.8 mmol), Fe(NO₃)₃.9H₂O (1.61 g, 4.0 mmol) and TEOS (tetraethyl orthosilicate) (0.67 g, 3.2 mmol). The round bottom flask containing the solution was placed in an ultrasonic bath and treated for 5 minutes. Fumed silica (10.07 g, primary particle average particle size=7 nm) was added to the precursor solution and the suspension was sonicated for 2 h at the room temperature. Then, the water from the pink suspension was removed on a rotary evaporator. Meanwhile, the color of the suspension has changed from pink to orange. Water bath temperature was adjusted to 60° C. The orange residue was transferred to a crystallizing dish and dried at 100° C. for 12 hours. The sand-colored solid was cooled to room temperature and grounded to a powder. A part of this powder was distributed in three ceramic shells and placed in a horizontally arranged quartz glass tube reactor mounted in a heating furnace. First, the reactor was rinsed thoroughly with nitrogen (36 ml·min⁻¹) for 10 minutes at room temperature. The annealing was carried out in a hydrogen atmosphere with a flow rate of 50 ml·min⁻¹. The metal-loaded silica was heated within 75 min to 850° C. and this temperature was maintained constant for 5 h. Finally, the gray samples were cooled to room temperature and characterized.

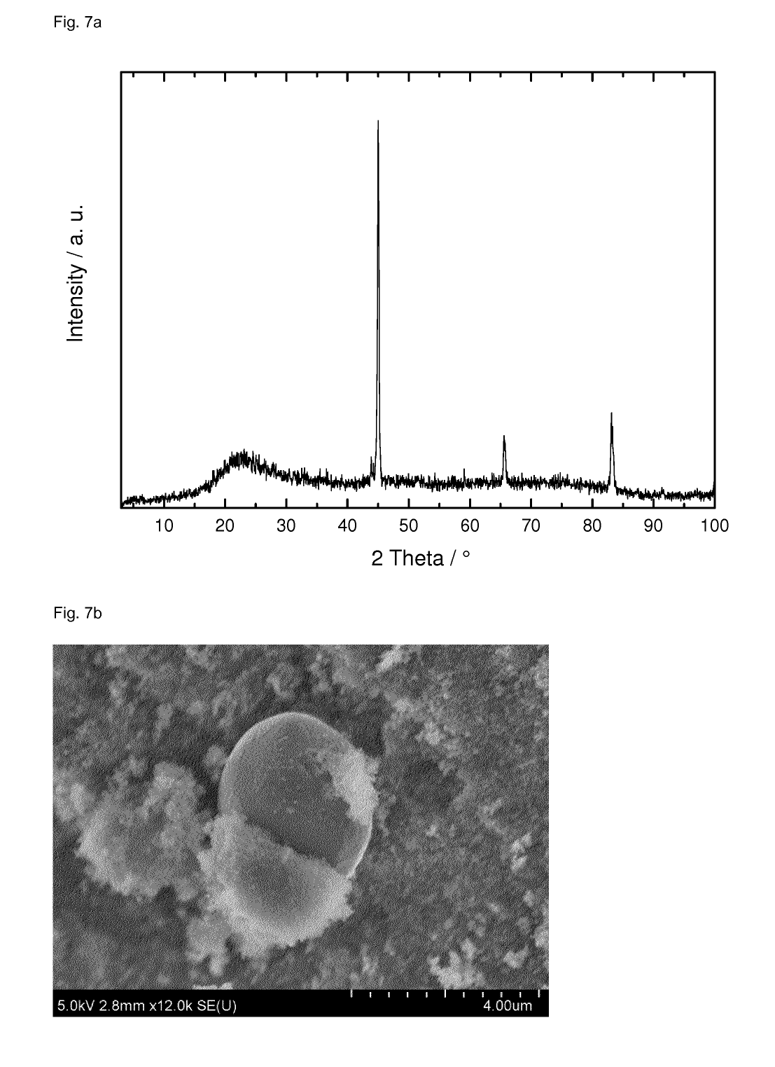

The X-ray diffraction pattern of Co₂FeSi on SiO₂ for the angle range 2θ=3-100° is shown in FIG. 7a. The sharp reflections between 2θ=40-100° are caused by crystalline nanoparticles, and display the crystalline structure of the Heusler compound.

FIG. 7b displays a particle of Co₂FeSi on SiO₂ as obtained from scanning electron microscopy of the sample from Example 7.

### Example 8: Co₂FeGa on SiO₂ (“Co₂FeGa@SiO₂”)

Supported Co₂FeGa nanoparticles on SiO₂ were prepared by synthesis as described in Example 5. The sample was placed in the quartz glass tube reactor, rinsed thoroughly with nitrogen (36 ml·min⁻¹) for 10 minutes and then annealed in a hydrogen/nitrogen (5/95) atmosphere with a flow rate of 50 ml·min⁻¹. The metal-loaded silica was heated within 75 min to 850° C. and this temperature was maintained constant for 5 h.

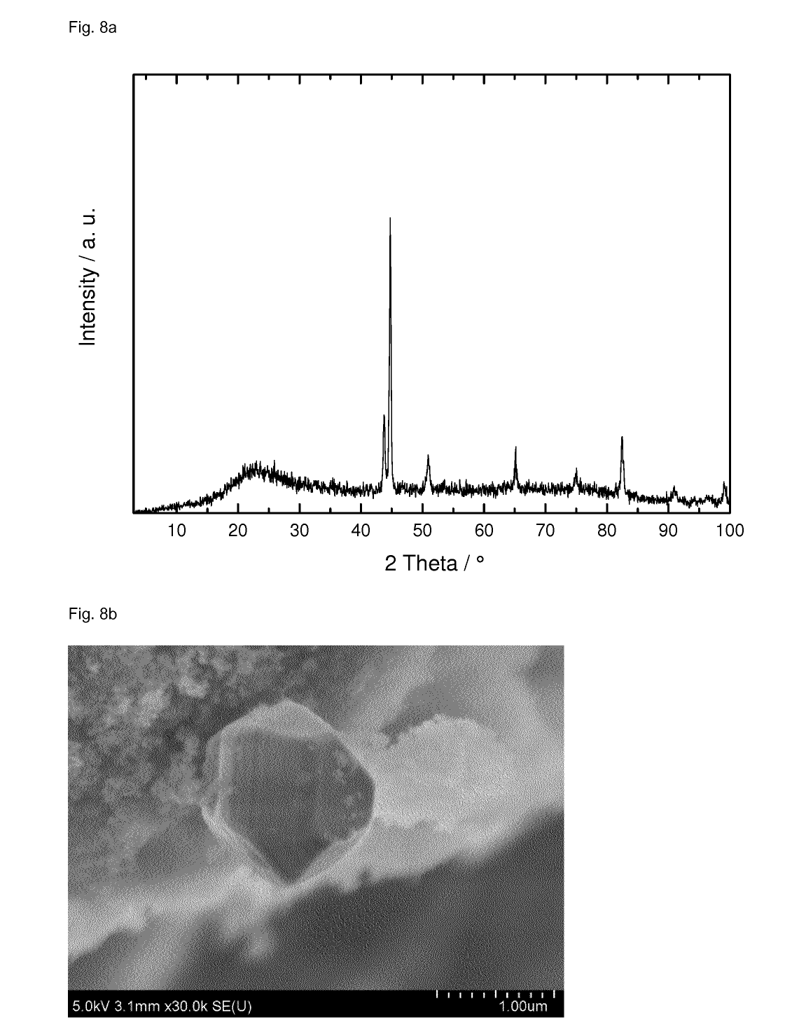

The X-ray diffraction pattern of Co₂FeGa on SiO₂ for the angle range 2θ=3-100° is shown in FIG. 8a. The sharp reflections between 2θ=40-100° are caused by crystalline nanoparticles, and display the crystalline structure of the Heusler compound.

FIG. 8b displays a particle of Co₂FeGa on SiO₂ as obtained from scanning electron microscopy of the sample from Example 8.

FIGS. 29 to 35 display High Angle Annular Dark Field-Scanning Transmission Electron Microscopy (HAADF-STEM) images obtained for the sample from Example 8.

FIGS. 36 to 38 display Scanning Electron Microscopy images obtained with detection of backscattered electrons (SEM-BSE) for the sample from Example 8.

FIG. 39 displays the particle size distribution for the particles mainly having a particle diameter of less than 400 nm as obtained from the HAADF-STEM images. Analysis of the results affords an average particle size D50 of 86.6 nm for the ternary intermetallic compound particles in the sample of Example 8.

FIG. 40 displays the particle size distribution for the particles mainly having a particle diameter of 400 nm or greater as obtained from the SEM-BSE images.

### Example 9: Co₂FeAl on SiO₂ (“Co₂FeAl@SiO₂”)

Supported Co₂FeAl nanoparticles on SiO₂ were prepared by synthesis as described in Example 6. The sample was placed in the quartz glass tube reactor, rinsed thoroughly with nitrogen (36 ml·min⁻¹) for 10 minutes and then annealed in a hydrogen/nitrogen (5/95) atmosphere with a flow rate of 50 ml·min⁻¹. The metal-loaded silica was heated within 75 min to 850° C. and this temperature was maintained constant for 5 h.

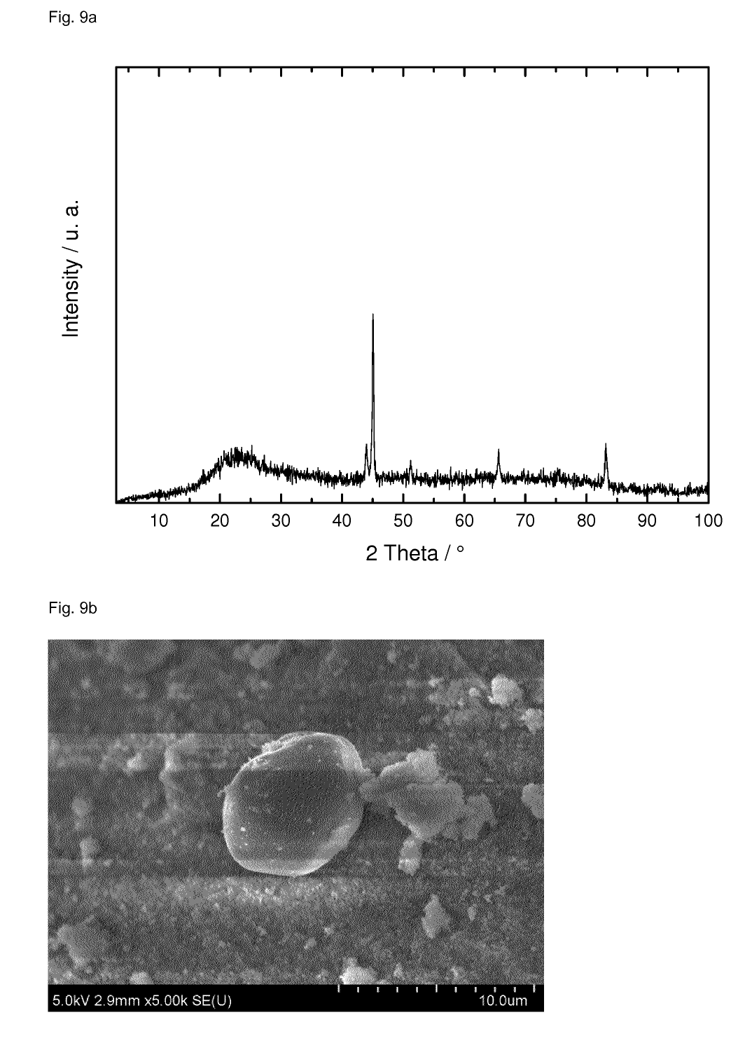

The X-ray diffraction pattern of Co₂FeAl on SiO₂ for the angle range 2θ=3-100° is shown in FIG. 9a. The sharp reflections between 2θ=40-100° are caused by crystalline nanoparticles, and display the crystalline structure of the Heusler compound.

FIG. 9b displays a particle of Co₂FeAl on SiO₂ as obtained from scanning electron microscopy of the sample from Example 9.

### Example 10: Co₂FeSi on SiO₂ (“Co₂FeSi@SiO₂”)

Supported Co₂FeSi nanoparticles on SiO₂ were prepared by synthesis as described in Example 7. The sample was placed in the quartz glass tube reactor, rinsed thoroughly with nitrogen (36 ml·min⁻¹) for 10 minutes and then annealed in a hydrogen/nitrogen (5/95) atmosphere with a flow rate of 50 ml·min⁻¹. The metal-loaded silica was heated within 75 min to 850° C. and this temperature was maintained constant for 5 h.

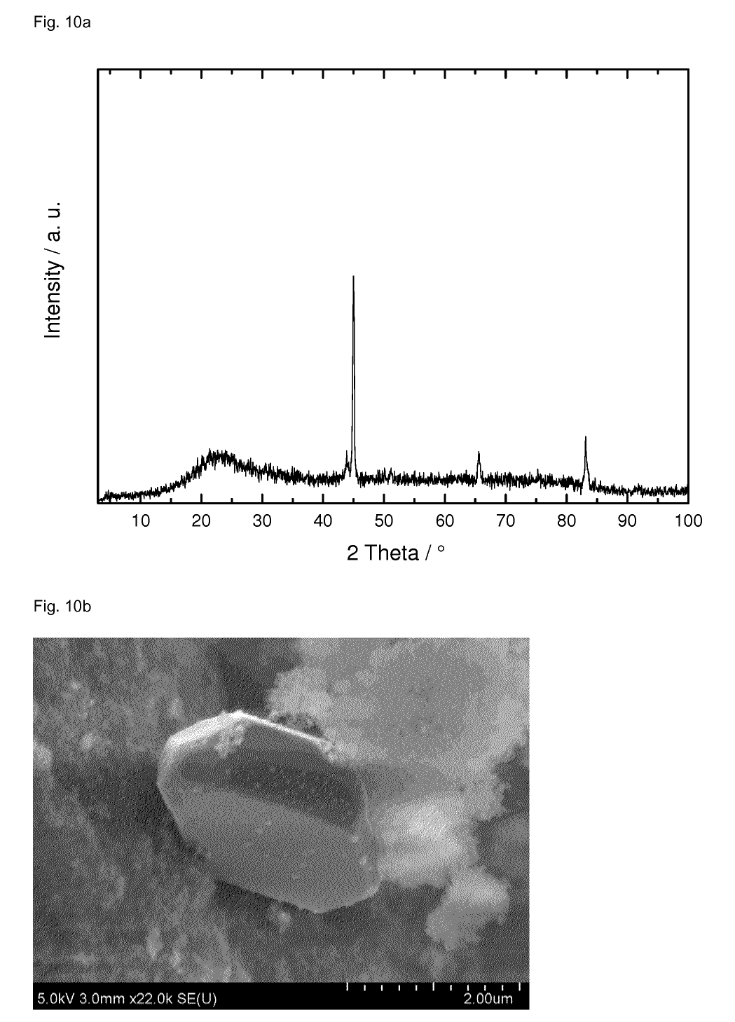

The X-ray diffraction pattern of Co₂FeSi on SiO₂ for the angle range 2θ=3-100° is shown in FIG. 10a. The sharp reflections between 2θ=40-100° are caused by crystalline nanoparticles, and display the crystalline structure of the Heusler compound.

FIG. 10b displays a particle of Co₂FeSi on SiO₂ as obtained from scanning electron microscopy of the sample from Example 10.

### Example 11: Co₂FeIn on SiO₂ (“Co₂FeIn@SiO₂”)

Supported Co₂FeIn nanoparticles on SiO₂ were prepared by synthesis as described in Example 4. The sample was placed in the quartz glass tube reactor, rinsed thoroughly with nitrogen (36 ml·min⁻¹) for 10 minutes and then annealed in a hydrogen/nitrogen (5/95) atmosphere with a flow rate of 50 ml·min⁻¹. The metal-loaded silica was heated within 75 min to 850° C. and this temperature was maintained constant for 5 h.

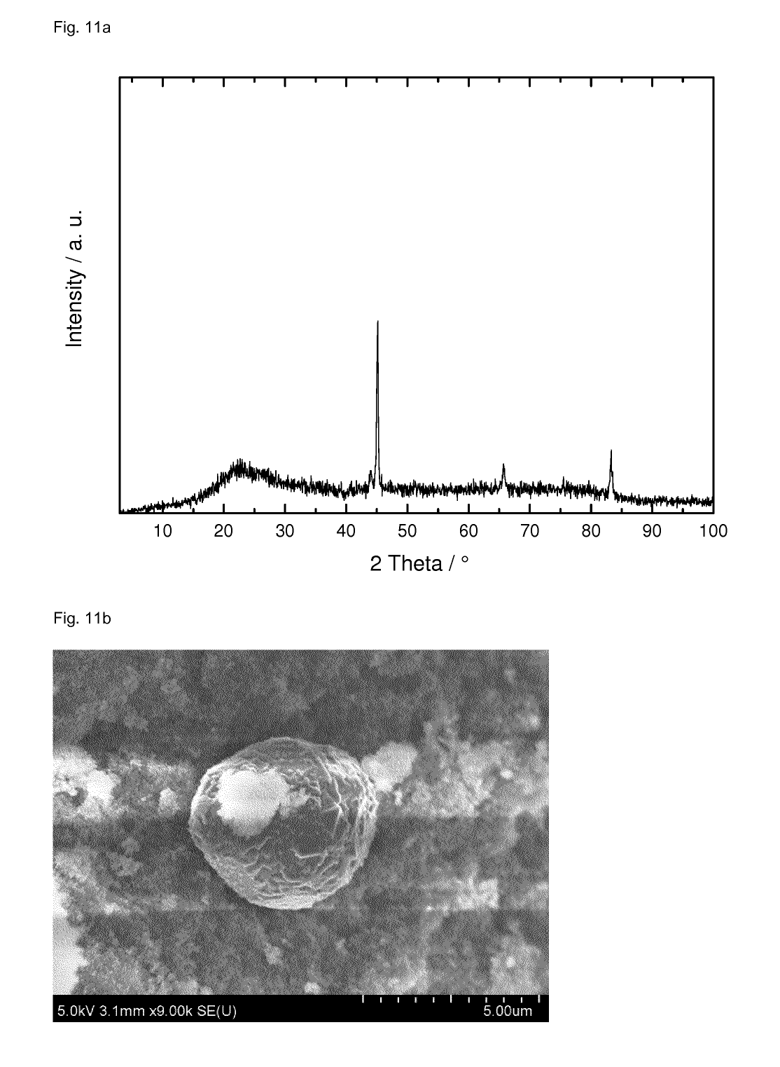

The X-ray diffraction pattern of Co₂FeIn on SiO₂ for the angle range 2θ=3-100° is shown in FIG. 11a. The sharp reflections between 2θ=40-100° are caused by crystalline nanoparticles, and display the crystalline structure of the Heusler compound.

FIG. 11b displays a particle of Co₂FeIn on SiO₂ as obtained from scanning electron microscopy of the sample from Example 11.

### Example 12: Cu₂FeAl on SiO₂ (“Cu₂FeAl@SiO₂”)

Distilled water (500 ml) was supplied to Cu(NO₃).2½H₂O (2.51 g, 10.8 mmol), Fe(NO₃)₃.9H₂O (1.62 g, 4.0 mmol) and AlCl₃.6H₂O (0.77 g, 3.2 mmol). The round bottom flask containing the solution was placed in an ultrasonic bath and treated for 5 minutes. Fumed silica (10.03 g, primary particle average particle size=7 nm) was added to the precursor solution and the suspension was sonicated for 2 h at the room temperature. Then, the water from the light green suspension was removed on a rotary evaporator. Water bath temperature was adjusted to 60° C. The green residue was transferred to a crystallizing dish and dried at 100° C. for 12 hours. The yellow brown red colored solid was cooled to room temperature and grounded to a powder. A part of this powder was distributed in three ceramic shells and placed in a horizontally arranged quartz glass tube reactor mounted in a heating furnace. First, the reactor was rinsed thoroughly with nitrogen (43 ml·min⁻¹) for 10 minutes at room temperature. The annealing was carried out in a hydrogen/nitrogen (5/95) atmosphere with a flow rate of 50 ml·min⁻¹. The metal-loaded silica was heated within 75 min to 850° C. and this temperature was maintained constant for 5 h. Finally, the red samples were cooled to room temperature and characterized.

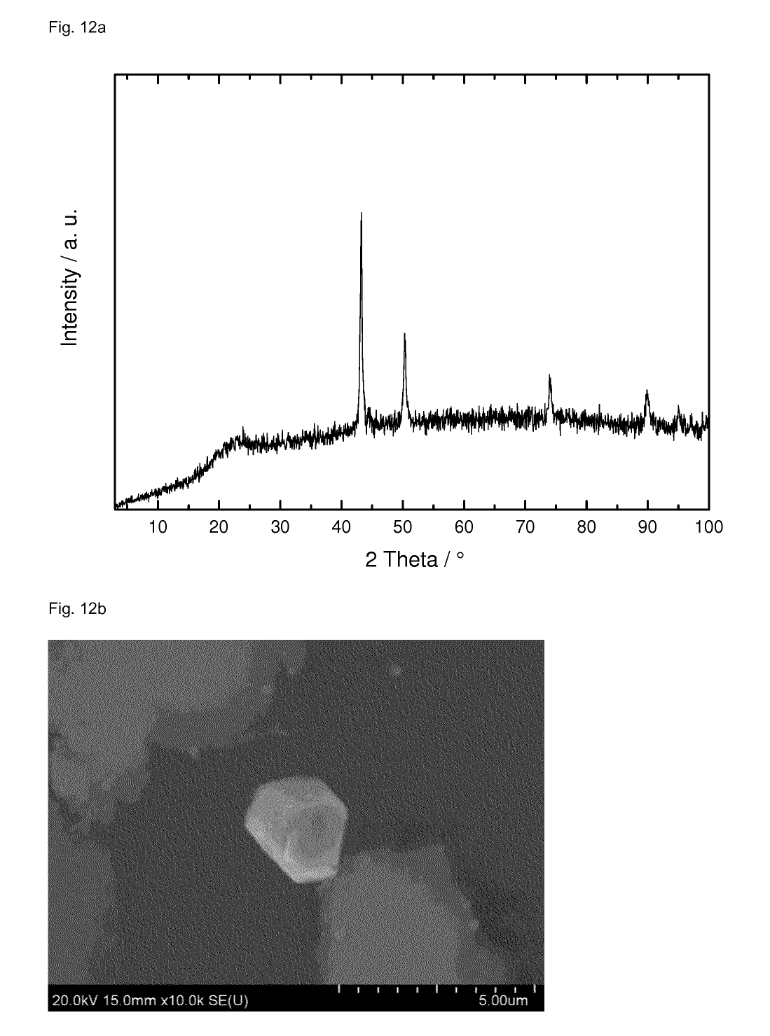

The X-ray diffraction pattern of Cu₂FeAl on SiO₂ for the angle range 2θ=3-100° is shown in FIG. 12a. The sharp reflections between 2θ=40-100° are caused by crystalline nanoparticles, and display the crystalline structure of the Heusler compound. Based on the results of simulation calculations, an assignment of the experimentally observed reflections could be made. The reflexes indicate an ordered superstructure. However, because of the strong noise and the small intensity in the range 2θ=10-40° the characteristic signals for the L2₁ phase may not observed.

FIG. 12b displays a particle of Cu₂FeAl on SiO₂ as obtained from scanning electron microscopy of the sample from Example 12.

### Example 13: Cu₂FeSi on SiO₂ (“Cu₂FeSi@SiO₂”)

In a typical example, distilled water (500 ml) was supplied to Cu(NO₃).2½H₂O (2.51 g, 10.8 mmol), Fe(NO₃)₃.9H₂O (1.62 g, 4.0 mmol) and TEOS (tetraethyl orthosilicate) (0.67 g, 3.2 mmol). The round bottom flask containing the solution was placed in an ultrasonic bath and treated for 5 minutes. Fumed silica (10.02 g, primary particle average particle size=7 nm) was added to the precursor solution and the suspension was sonicated for 2 h at the room temperature. Then, the water from the light green suspension was removed on a rotary evaporator. Water bath temperature was adjusted to 60° C. The green residue was transferred to a crystallizing dish and dried at 100° C. for 12 hours. The brown red colored solid was cooled to room temperature and grounded to a powder. A part of this powder was distributed in three ceramic shells and placed in a horizontally arranged quartz glass tube reactor mounted in a heating furnace. First, the reactor was rinsed thoroughly with nitrogen (45 ml·min⁻¹) for 10 minutes at room temperature. The annealing was carried out in a hydrogen/nitrogen (5/95) atmosphere with a flow rate of 50 ml·min⁻¹. The metal-loaded silica was heated within 75 min to 850° C. and this temperature was maintained constant for 5 h. Finally, the red samples were cooled to room temperature and characterized.

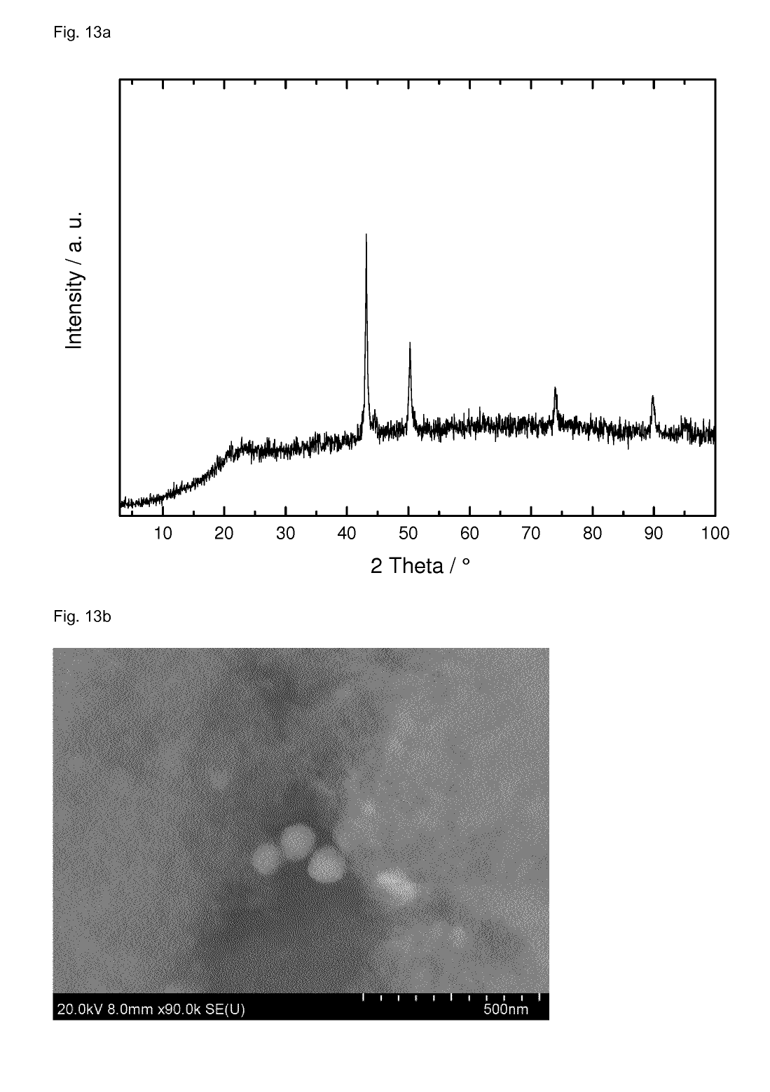

The X-ray diffraction pattern of Cu₂FeSi on SiO₂ for the angle range 2θ=3-100° is shown in FIG. 13a. The sharp reflections between 2θ=40-100° are caused by crystalline nanoparticles, and display the crystalline structure of the Heusler compound. Based on the results of simulation calculations, an assignment of the experimentally observed reflections could be made. The reflexes indicate an ordered superstructure. However, because of the strong noise and the small intensity in the range 2θ=10-40° the characteristic signals for the L2₁ phase may not observed.

FIG. 13b displays a particle of Cu₂FeSi on SiO₂ as obtained from scanning electron microscopy of the sample from Example 13.

### Example 14: Fe₂MnGa on γ-Al₂O₃ (“Fe₂MnGa@Al₂O₃”)

In a typical example, water (1.5 mL) was supplied to Fe(NO₃)₃.9H₂O (0.36 g, 0.89 mmol), Mn(NO₃)₂.4H₂O (0.11 g, 0.45 mmol) and Ga(NO₃)₃.xH₂O (0.19 g, 0.45 mmol). The mixture was placed in an ultrasonic bath and treated for 5 minutes to form a solution. Aluminium oxide (γ-Al₂O₃, 2.00 g, particle size D50=25 μm; Fa. Sasol, Puralox SCFa-230) was supplied to a crystallizing dish and the precursor solution was added drop wise under constant steering (incipient wetness impregnation). The wet solid was dried at 100° C. for 18 hours. The solid was cooled to room temperature and grounded to a powder. The powder was distributed in three ceramic shells and placed in a horizontally arranged quartz glass tube reactor mounted in a heating furnace. First, the reactor was rinsed thoroughly with nitrogen (45 mL·min⁻¹) for 10 minutes at room temperature. The annealing was carried out with 10 vol % hydrogen in nitrogen with a flow rate of 50 ml·min⁻¹. The metal-loaded aluminium oxide was heated with a rate of 11.5 K·min⁻¹ to 850° C. and this temperature was maintained constant for 5 h. Finally, the sand-colored samples were passive cooled to room temperature and characterized.

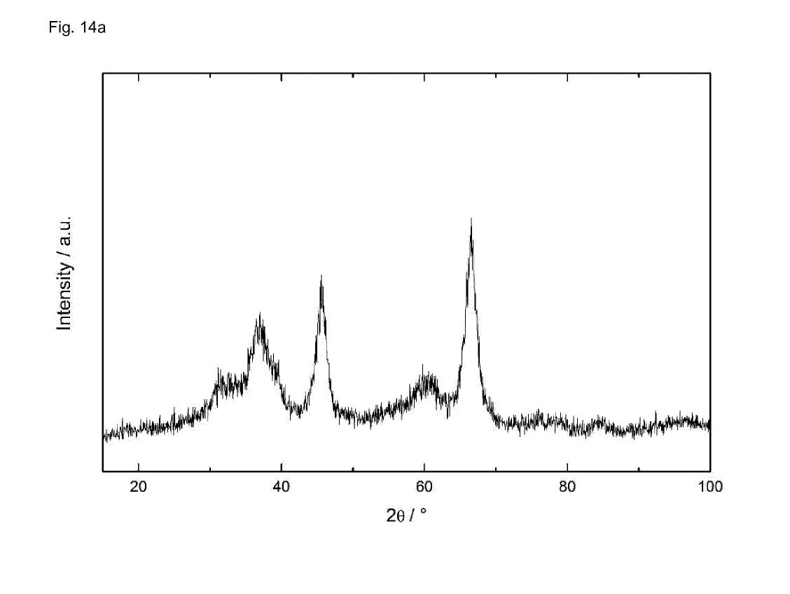

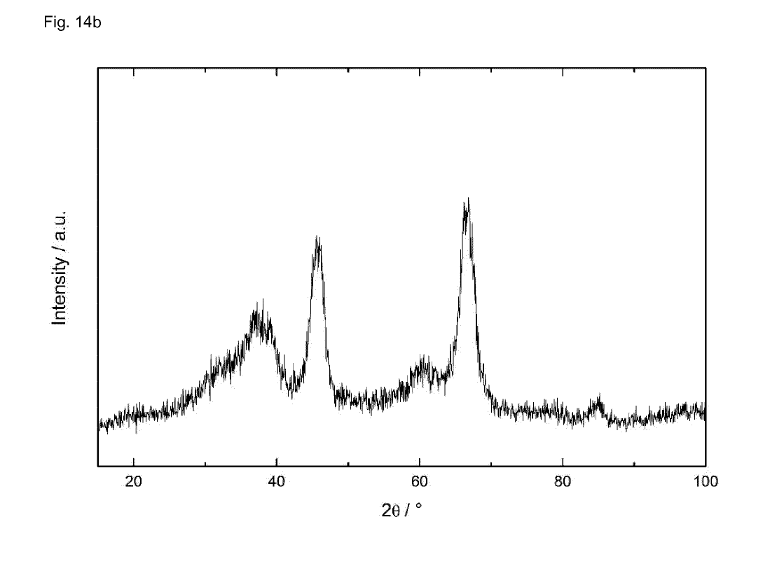

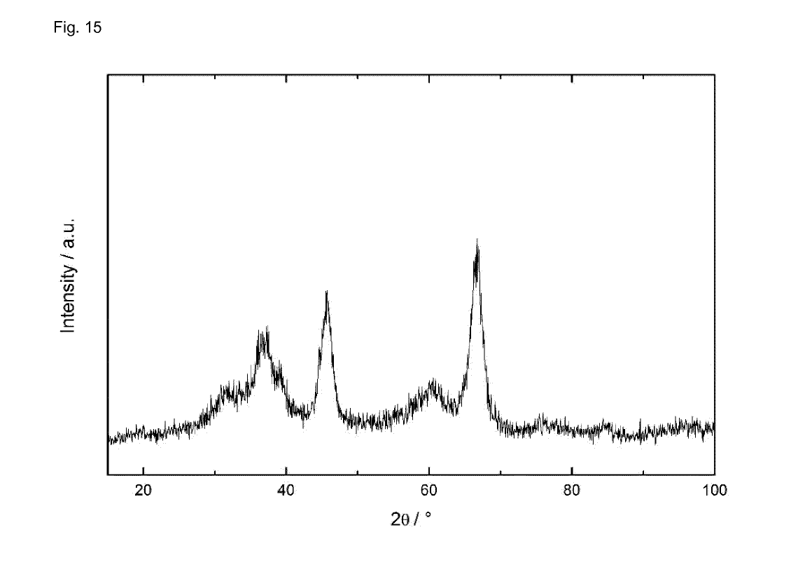

The X-ray diffraction pattern of Fe₂MnGa on γ-Al₂O₃ for the angle range 2θ=3-100° is shown in FIG. 14a. As may be taken from a comparison of the diffraction pattern in FIG. 14a with the XRD pattern of pure γ-Al₂O₃ shown in FIG. 14b, the pattern of the latter overlays the reflections of the ternary intermetallic compound Fe₂MnGa.

### Example 15: Fe₂MnSi on γ-Al₂O₃ (“Fe₂MnSi@Al₂O₃”)

In a typical example, water (1.4 mL) was supplied to Fe(NO₃)₃.9H₂O (0.44 g, 1.08 mmol), Mn(NO₃)₂.4H₂O (0.14 g, 0.54 mmol) and Si(OC₂H₅)₄ (0.11 g, 0.54 mmol). The mixture was placed in an ultrasonic bath and treated for 5 minutes to form a solution. Aluminium oxide (γ-Al₂O₃, 2.00 g, particle size D50=25 μm; Fa. Sasol, Puralox SCFa-230) was supplied to a crystallizing dish and the precursor solution was added drop wise under constant steering (incipient wetness impregnation). The wet solid was dried at 100° C. for 18 hours. The solid was cooled to room temperature and grounded to a powder. The powder was distributed in three ceramic shells and placed in a horizontally arranged quartz glass tube reactor mounted in a heating furnace. First, the reactor was rinsed thoroughly with nitrogen (45 mL·min⁻¹) for 10 minutes at room temperature. The annealing was carried out with 10 vol % hydrogen in nitrogen with a flow rate of 50 ml·min⁻¹. The metal-loaded aluminium oxide was heated with a rate of 11.5 K·min⁻¹ to 850° C. and this temperature was maintained constant for 5 h. Finally, the light gray samples were passive cooled to room temperature.

The X-ray diffraction pattern of Fe₂MnSi on γ-Al₂O₃ for the angle range 2θ=3-100° is shown in FIG. 15. As may be taken from a comparison of the diffraction pattern in FIG. 15 with the XRD pattern of pure γ-Al₂O₃ shown in FIG. 14b, the pattern of the latter overlays the reflections of the ternary intermetallic compound Fe₂MnSi.

### Example 16: Co₂CuAl on γ-Al₂O₃ (“Co₂CuAl@Al₂O₃”)

In a typical example, water (1.5 mL) was supplied to CoCl₂.6H₂O (0.24 g, 1.01 mmol), Cu(NO₃)₂.2.5H₂O (0.12 g, 0.51 mmol) and AlCl₃.6H₂O (0.18 g, 0.51 mmol). The mixture was placed in an ultrasonic bath and treated for 5 minutes to form a solution. Aluminium oxide (γ-Al₂O₃, 2.00 g, particle size D50=25 μm; Fa. Sasol, Puralox SCFa-230) was supplied to a crystallizing dish and the precursor solution was added drop wise under constant steering (incipient wetness impregnation). The wet solid was dried at 100° C. for 18 hours. The solid was cooled to room temperature and grounded to a powder. The powder was distributed in three ceramic shells and placed in a horizontally arranged quartz glass tube reactor mounted in a heating furnace. First, the reactor was rinsed thoroughly with nitrogen (45 mL·min⁻¹) for 10 minutes at room temperature. The annealing was carried out with 10 vol % hydrogen in nitrogen with a flow rate of 50 ml·min⁻¹. The metal-loaded aluminium oxide was heated with a rate of 11.5 K·min⁻¹ to 850° C. and this temperature was maintained constant for 5 h. Finally, the light blue samples were passive cooled to room temperature and characterized.

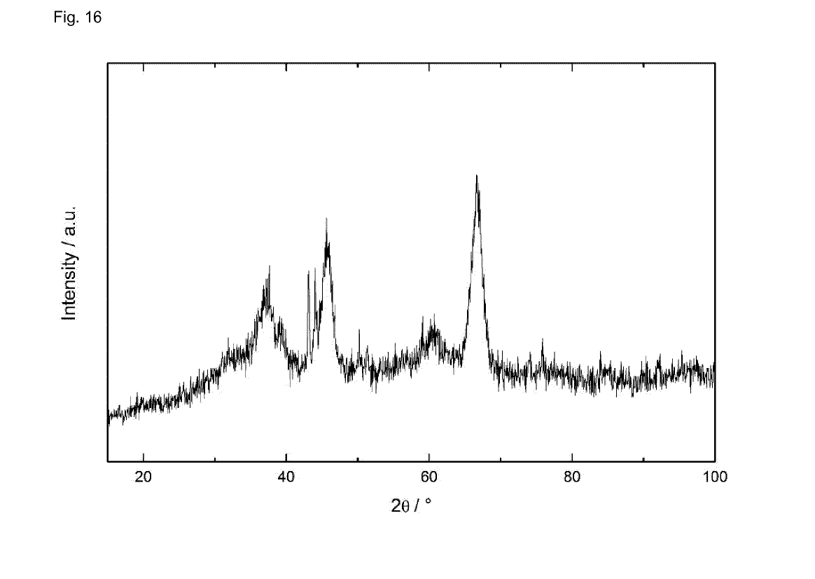

The X-ray diffraction pattern of Co₂CuAl on γ-Al₂O₃ for the angle range 2θ=3-100° is shown in FIG. 16. As may be taken from a comparison of the diffraction pattern in FIG. 16 with the XRD pattern of pure γ-Al₂O₃ shown in FIG. 14b, the pattern of the latter overlays the reflections of the ternary intermetallic compound Co₂CuAl.

### Example 17: Fe₂TiGa on γ-Al₂O₃ (“Fe₂TiGa@Al₂O₃”)

In a typical example, water (1.5 mL) was supplied to Fe(NO₃)₃.9H₂O (0.37 g, 0.92 mmol), TiCl₄ (0.07 g, 0.46 mmol) and Ga(NO₃)₃.xH₂O (0.18 g, 0.46 mmol). The mixture was placed in an ultrasonic bath and treated for 5 minutes to form a solution. Aluminium oxide (γ-Al₂O₃, 2.00 g, particle size D50=25 μm; Fa. Sasol, Puralox SCFa-230) was supplied to a crystallizing dish and the precursor solution was added drop wise under constant steering (incipient wetness impregnation). The wet solid was dried at 100° C. for 18 hours. The solid was cooled to room temperature and grounded to a powder. The powder was distributed in three ceramic shells and placed in a horizontally arranged quartz glass tube reactor mounted in a heating furnace. First, the reactor was rinsed thoroughly with nitrogen (45 mL·min⁻¹) for 10 minutes at room temperature. The annealing was carried out with 10 vol % hydrogen in nitrogen with a flow rate of 50 ml·min⁻¹. The metal-loaded aluminium oxide was heated with a rate of 11.5 K·min⁻¹ to 850° C. and this temperature was maintained constant for 5 h. Finally, the sand-colored samples were passive cooled to room temperature and characterized.

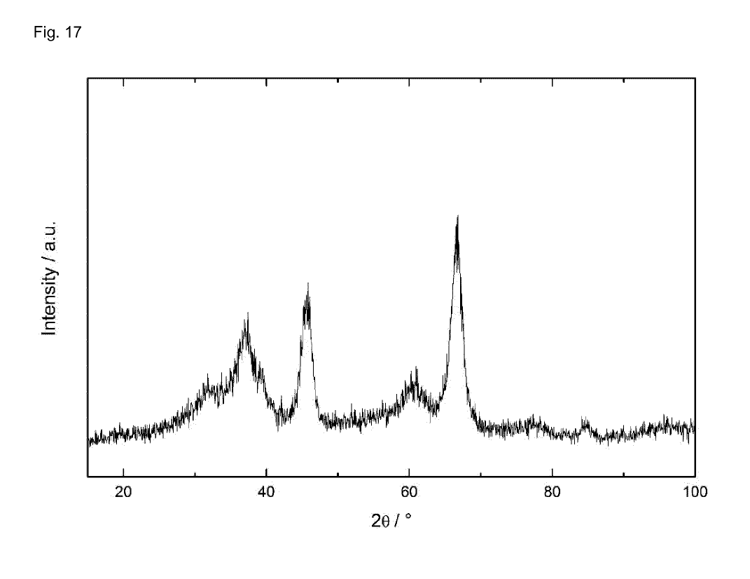

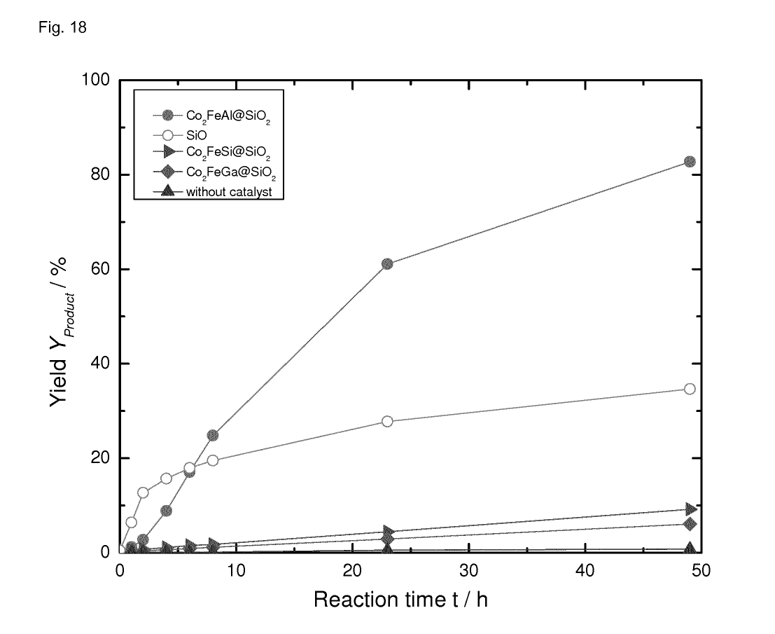

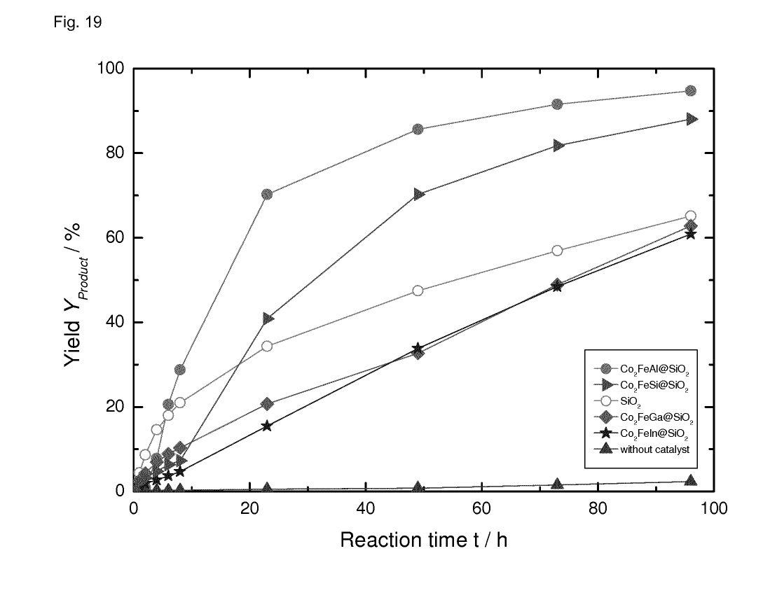

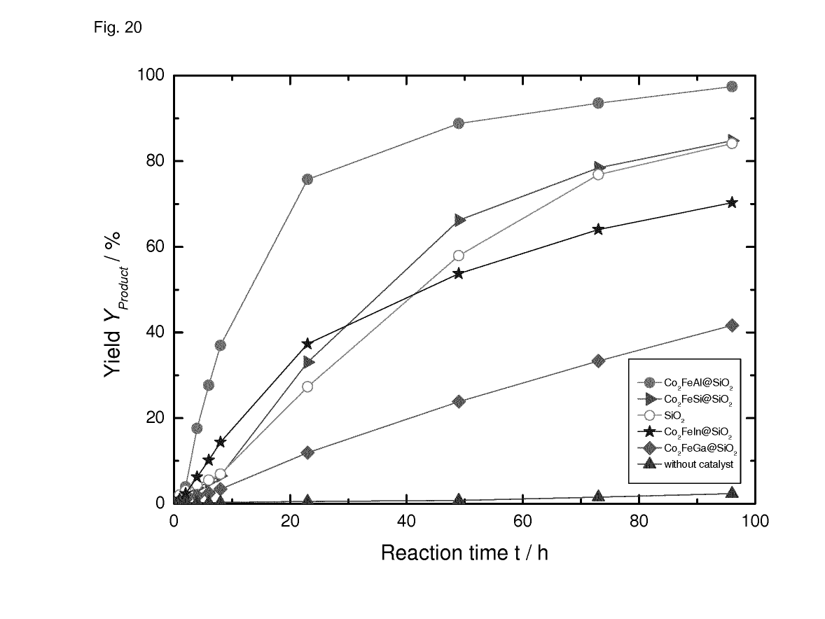

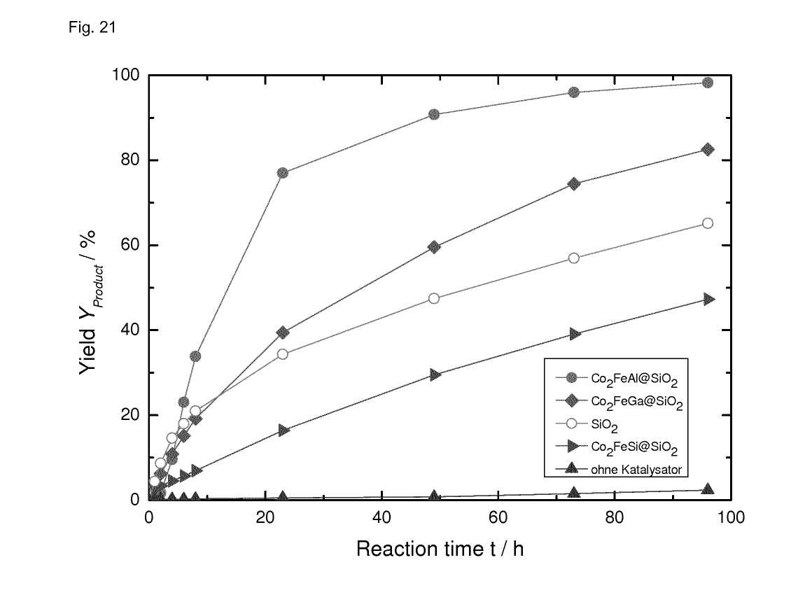

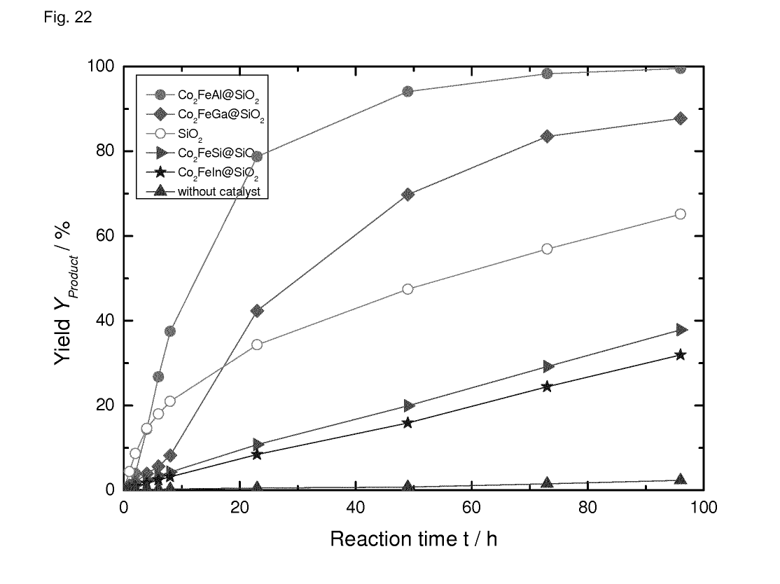

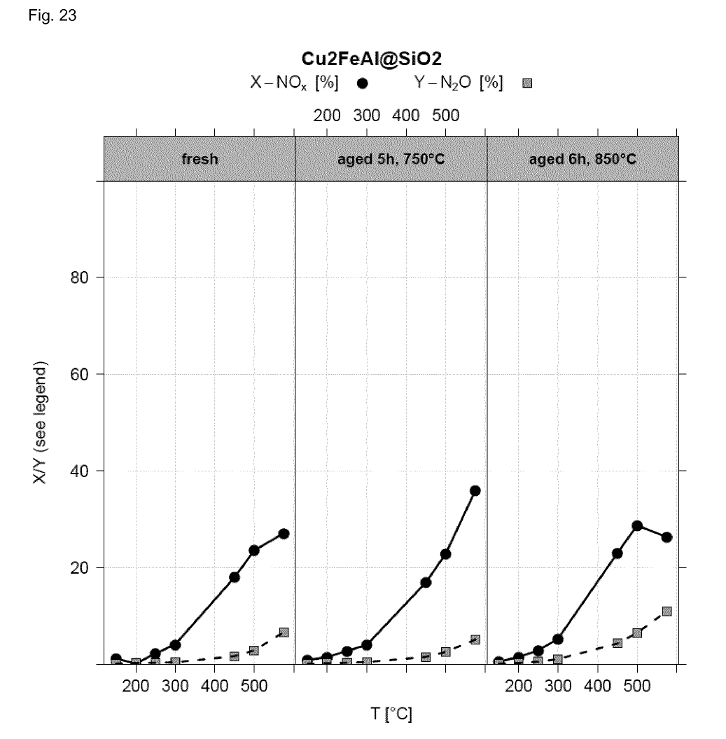

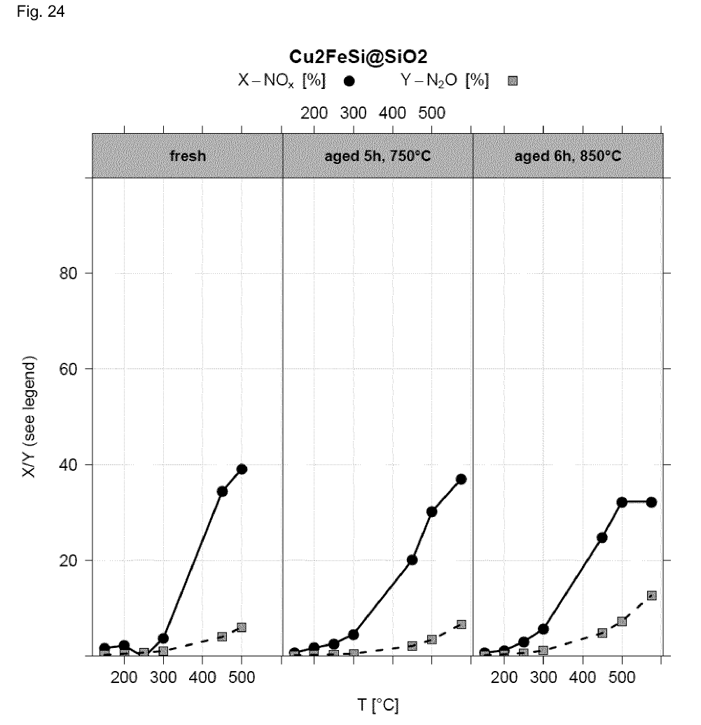

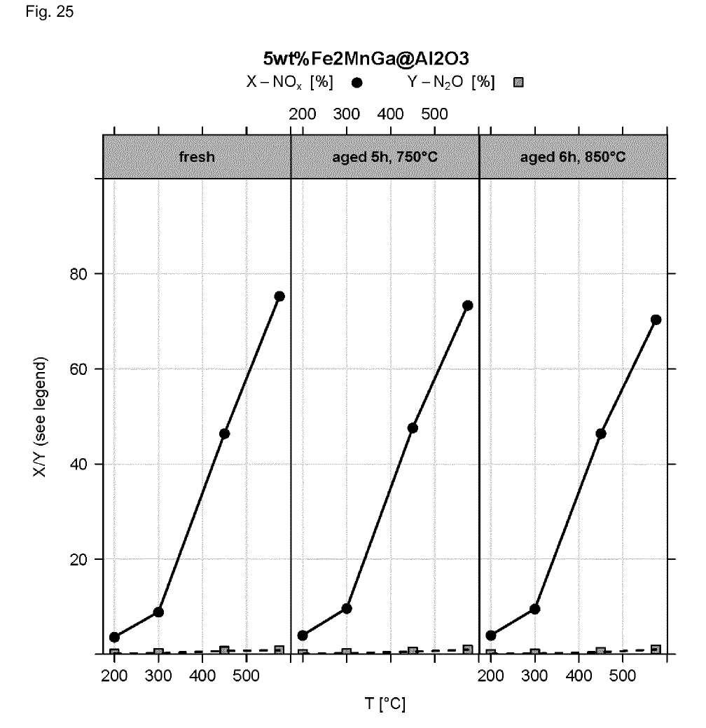

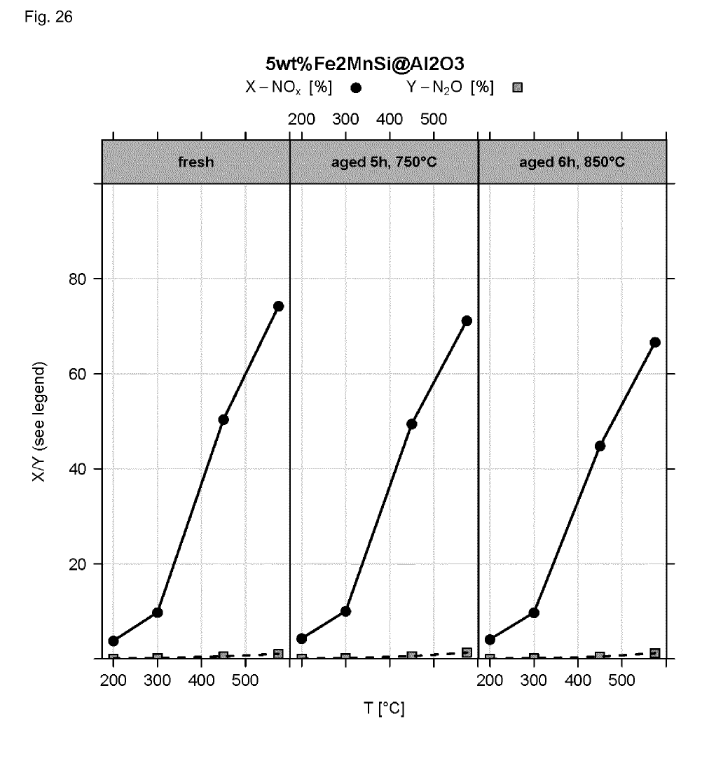

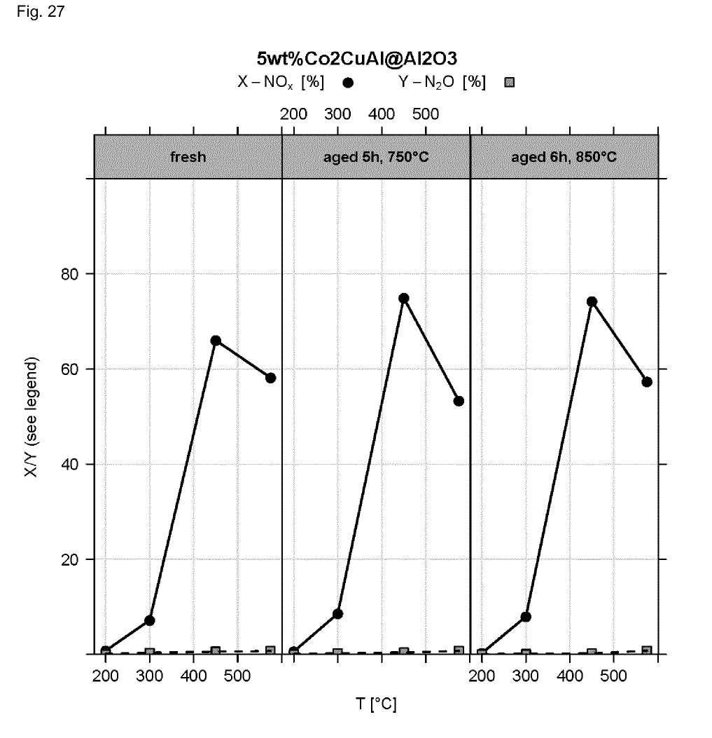

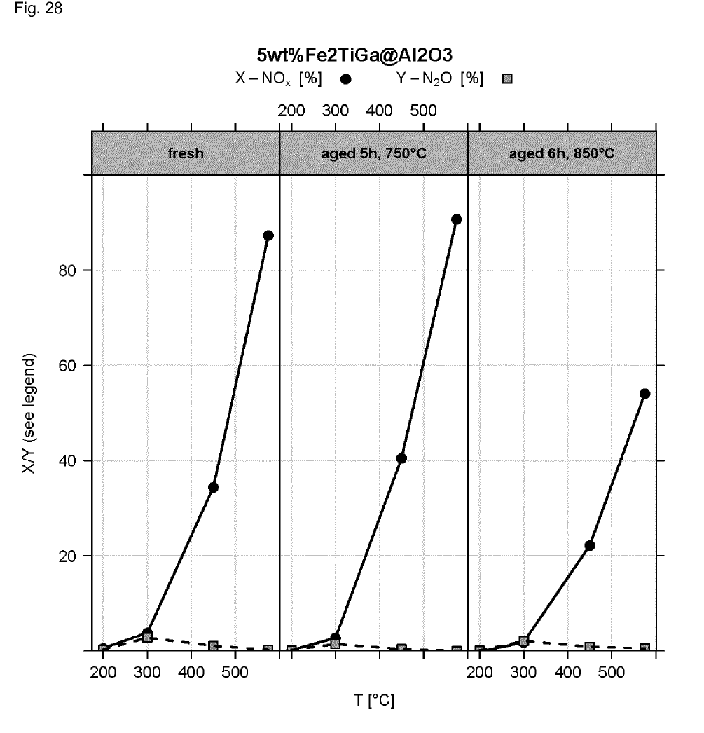

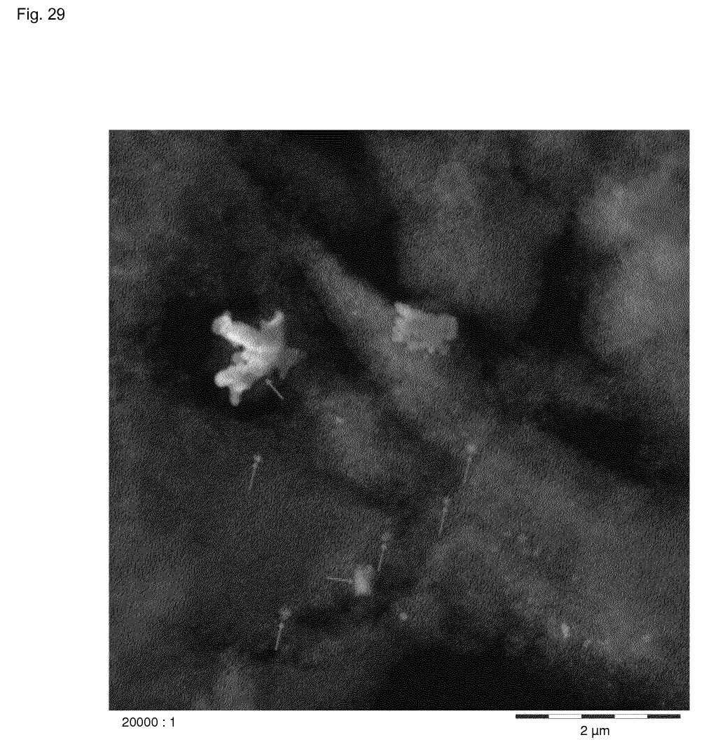

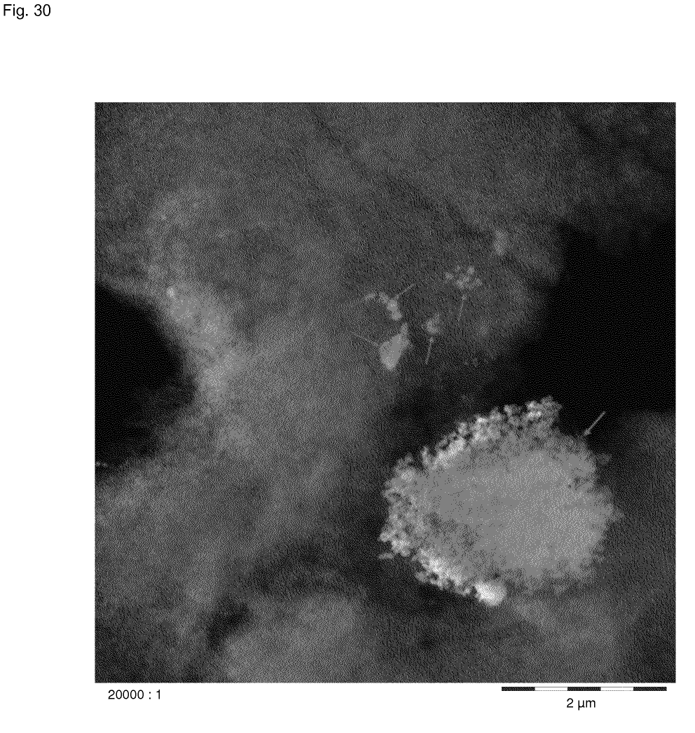

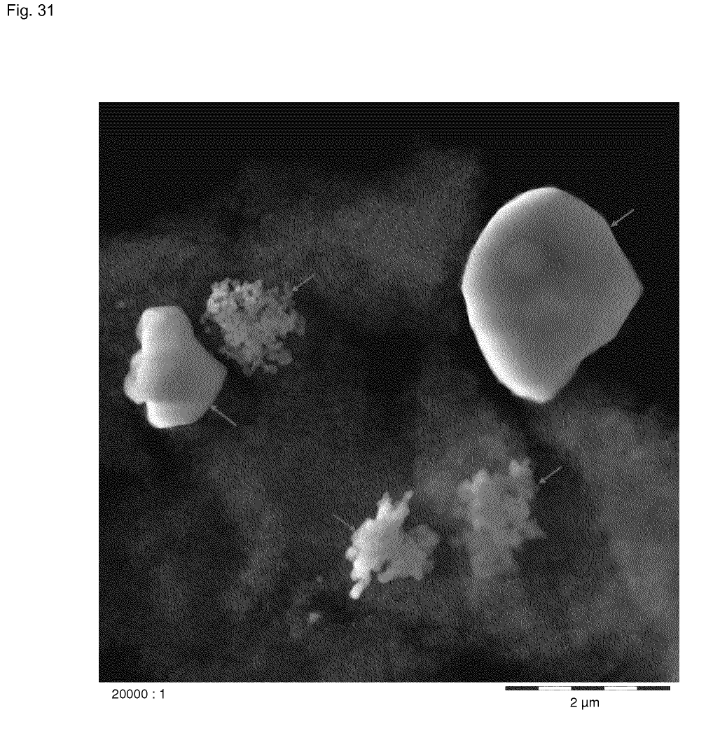

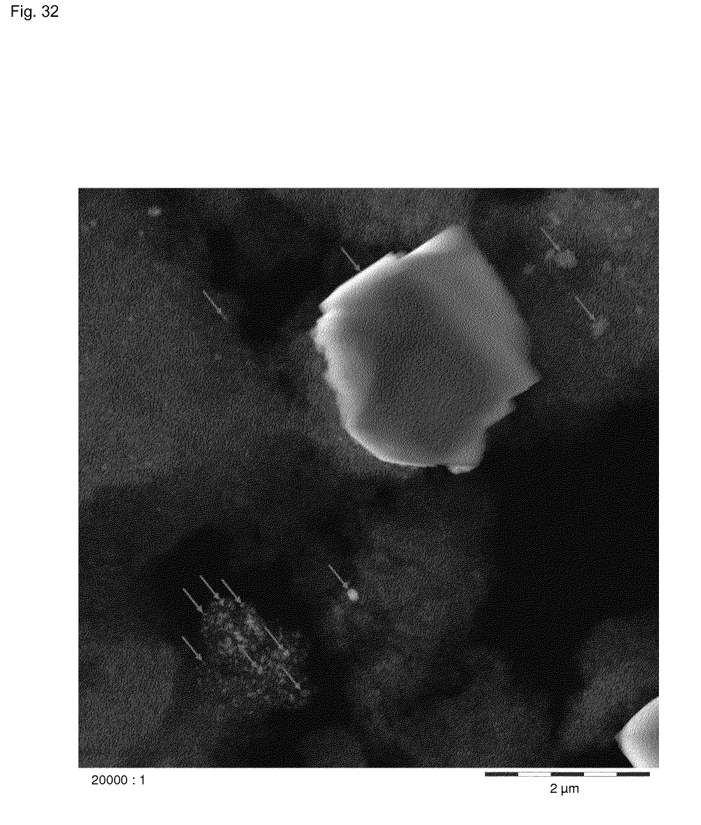

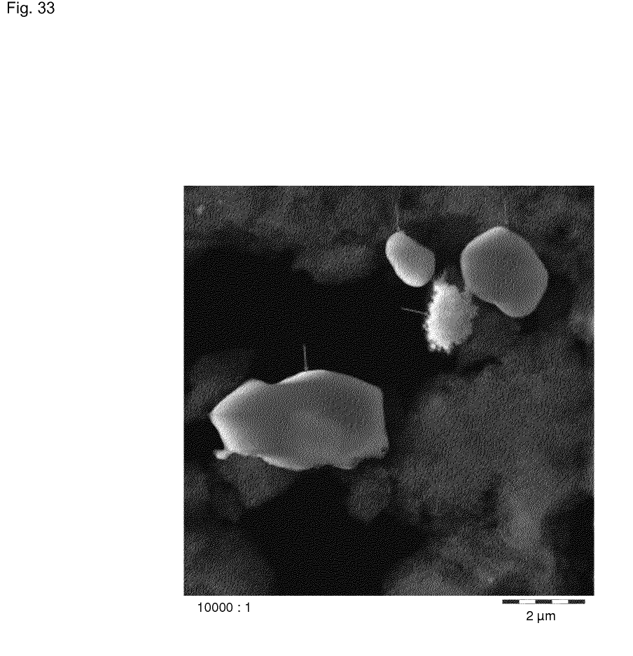

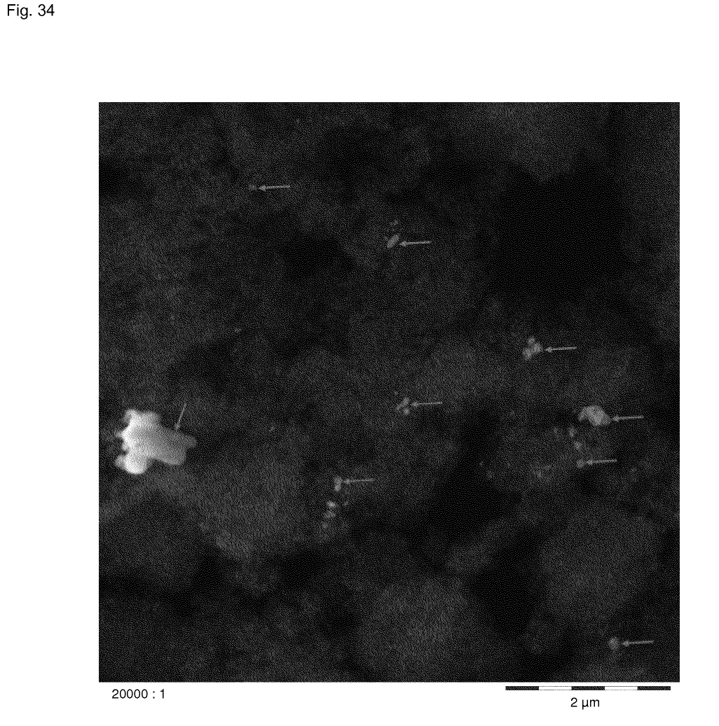

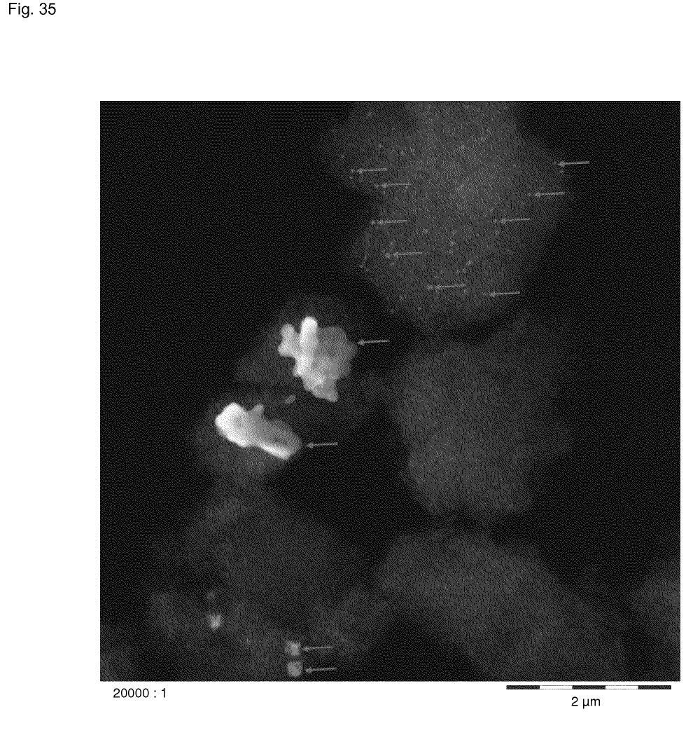

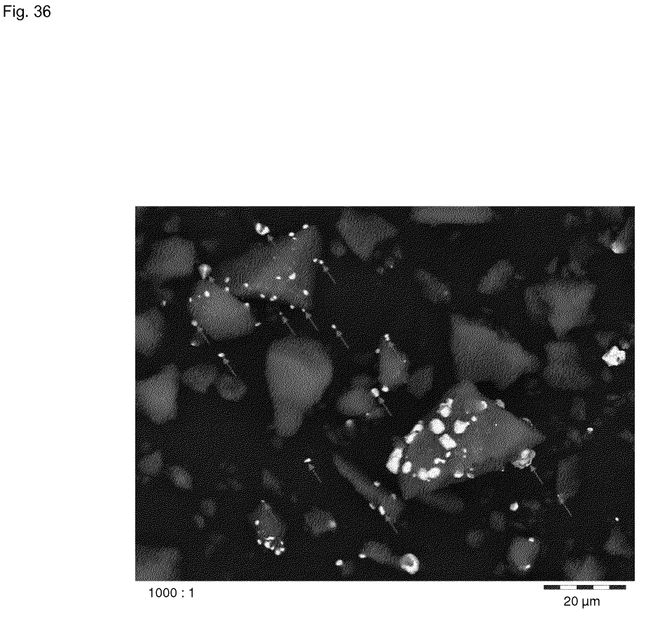

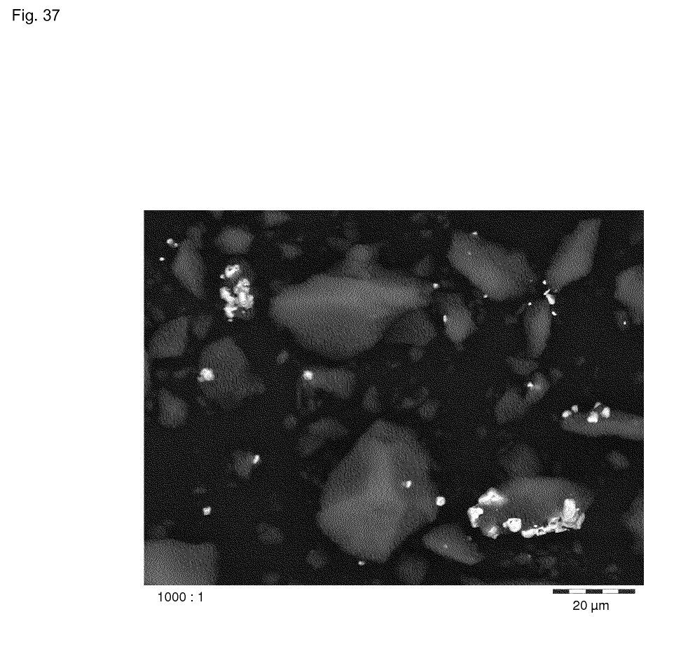

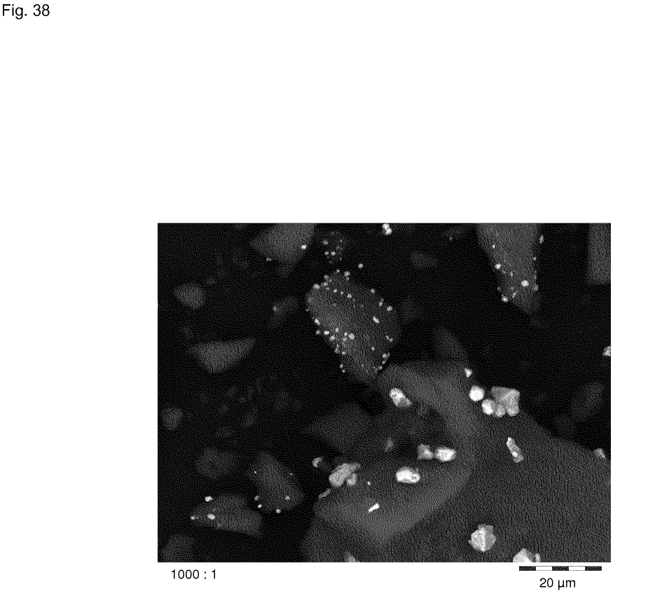

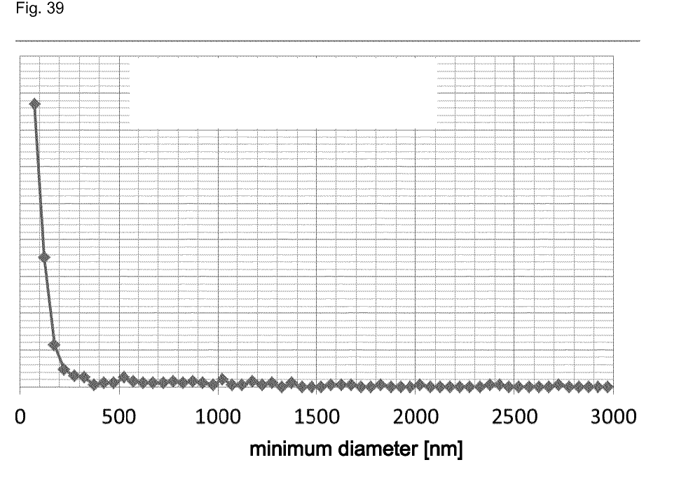

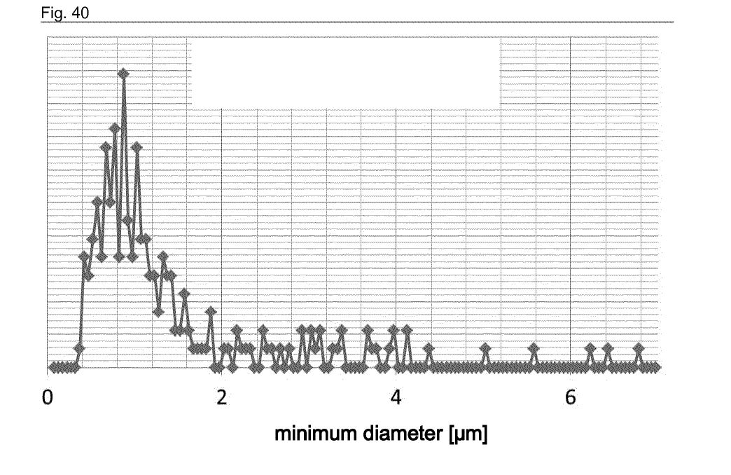

The X-ray diffraction pattern of Fe₂TiGa on γ-Al₂O₃ for the angle range 2θ=3-100° is shown in FIG. 17. As may be taken from a comparison of the diffraction pattern in FIG. 17 with the XRD pattern of pure γ-Al₂O₃ shown in FIG. 14b, the pattern of the latter overlays the reflections of the ternary intermetallic compound Fe₂TiGa.

### Example 18: Catalytic Testing Experiments Based on the Knoevenagel Condensation Reaction

The synthesized nanoparticles supported on SiO₂ as obtained from Examples 1-10 were used in a Knoevenagel condensation for the reaction of benzaldehyde with malononitrile to benzylidenemalononitrile (BMDN) and the composition of the product mixture are analyzed by gas chromatography. In a typical catalytic experiment 0.26 g (4 mmol) malononitrile, 0.42 g (4 mmol) of freshly distilled benzaldehyde, 10 ml of toluene as a solvent and 0.2 g of 1,4-dichlorobenzene as internal standard were mixed in a 50 ml two-necked flask equipped with a reflux condenser. The mixture was heated in an oil bath at 80° C. In general, 0.2 g of dried (12 h at 100° C.) catalyst was added. At regular time intervals the reaction mixture was analyzed by gas chromatography. The samples (0.2 μl) were injected into the heated GC injector block of a HP 6890 Series gas chromatograph (Hewlett-Packard). The assignment of the peaks of the analyzed mixture was compared with that of the calibration. A solution from each of the components of the reaction mixture with toluene and 1,4-dichlorobenzene was injected in the GC and analyzed. The gas chromatographic conditions are listed in Table 1 below.

TABLE 1
Gas chromatographic conditions employed in Example 18

| | |
|---|---|
| Sample volume | 0.2 μl |
| Injector temperature | 250° C. |
| Heating rate | Start at 70° C., 2 min isothermal |
| | Heating rate of 10 K · min⁻¹ to 250° C. |
| Carrier gas | Helium |
| Flow | 2.3 ml · min⁻¹ |
| Column head pressure | 0.8 bar |
| Split ratio | 50:1 |
| Column | HP-5 Trace Analysis 5% Phenyl Methyl Capillary |
| | (Length: 30 m, Inner diameter: 320 μm, |
| | Film thickness: 0.25 μm) |
| Detector | FID |

The activity of synthesized Heusler compounds from the respective examples were tested in the base-catalyzed reaction. Before the start of the test series benzaldehyde was distilled under reduced pressure to remove benzoic acid. The freshly distilled benzaldehyde was then stored under an inert gas atmosphere. In addition, for comparison, the reaction of benzaldehyde with malononitrile was carried out only over SiO₂. For the graphical analysis the yield of product was applied against the reaction time. The results obtained for Examples 1-3 are shown in FIG. 18, those obtained for Examples 4-6 are shown in FIGS. 19 and 20, respectively, and those obtained for Examples 9-10 are shown in FIGS. 21 and 22, respectively.

Thus, as may be taken from FIG. 18, in the reference reaction only using SiO₂, a low yield of product was detected. For Co₂FeGa@SiO₂ (Example 1) and Co₂FeSi@SiO₂ (Example 3) a low catalytic activity was also detected. The significantly higher activity of Co₂FeAl@SiO₂ (Example 2) is tentatively attributed to the high catalytic activity of aluminum.

As may be taken form FIG. 19, in the catalytic reaction of benzaldehyde with malononitrile with the catalyst samples which were prepared in water as the solvent (see synthetic procedures of Examples 4-6, respectively) a general increase of the product yield for all samples is observed compared to those prepared in methanol. Most active is Co₂FeAl@SiO₂ (Example 6) with approximately 95% yield, followed by Co₂FeSi@SiO₂ (Example 7) with 88% yield, Co₂FeGa@SiO₂ (Example 5) with 62% yield and Co₂FeIn@SiO₂ (Example 4) with 60% yield of BMDN. Upon repeating the reactions, it is observed that the order of activity of the prepared compounds is almost the same (see results displayed in FIG. 20). In this respect it is however noted that in FIG. 20, the Co₂FeIn@SiO₂ catalyst sample used was obtained according to Example 4 yet using water instead of methanol.

The compounds prepared in water and annealed in H₂/N₂ atmosphere were also investigated in Knoevenagel reaction. In FIG. 21 it can be seen that aluminum-containing compound Co₂FeAl@SiO₂ (Example 9) is most active. Then Co₂FeGa@SiO₂ (Example 8) follows with 82% yield and Co₂FeSi@SiO₂ (Example 10) with 48% yield of product. The results of the repeated reactions are shown in FIG. 22. One difference from the other samples (Example 1-7 in FIGS. 18-20) is that in reactions with Co₂FeGa@SiO₂ (Example 8) more product is formed than in those with Co₂FeSi@SiO₂ (Example 10).

### Example 19: SCR (Selective Catalytic Reduction) Testing

For the SCR test, the catalyst samples from Examples 12-17 were first mixed with a slurry of premilled gamma alumina (30 wt % Al₂O₃, 70 wt % catalyst). The slurry was dried under stirring on a magnetic stirring plate at 100° C., calcined (1 h, 600° C., air), and the resulting cake crushed and sieved to a target fraction of 250-500 μm for testing. Fractions of the respective shaped powders were aged in a muffle oven for 5 h at 750° C. in 10% steam/air and for 6 h at 850° C. in 10% steam/air.

SCR tests were then performed using a 48 fold parallel testing unit equipped with ABB LIMAS NOx/NH3 and ABB URAS N₂O analyzers. For each fresh and aged catalyst, 170 mg of the shaped powder diluted with corundum to a total volume of 1 mL were placed in each reactor. Under isothermal conditions (T=150, 200, 250, 300, 450, 500, 575° C.) a feed gas consisting of 500 ppm NO, 500 ppm NH3, 5% O2, 10% H₂O balance N₂ was passed at a GHSV of 80,000 h⁻¹ through the catalyst bed. In addition to 30 min equilibration time for thermal equilibration of the parallel reactor at each temperature, every position was equilibrated for 3.5 min followed by 30 sec sampling time. Data recorded by the analyzers at a frequency of 1 Hz was averaged for the sampling interval and used to calculate NO conversions and N₂O yield.

The results obtained for the samples prepared from Examples 12-17 are displayed in FIGS. 23-28, respectively. Thus, as may be taken from the results, the samples from Examples 12 and 13 on silica (“Cu₂FeAl@SiO₂” and “Cu₂FeSi@SiO₂”) only display a moderate activity when employed in SCR, which nevertheless is not diminished after ageing. Furthermore, the aforementioned samples display a certain activity relative to the conversion of N₂O which is not observed by the samples prepared from Examples 14-17 on gamma-alumina.

As regards the results obtained for the samples from Examples 14-17 on gamma-alumina, on the other hand, these display a surprisingly high acitivity with respect to the conversion of NOₓ, wherein it is observed that the samples containing Fe display a progressive increase in their ability to reduce NOₓ emission, whereas the sample containing Co displays a rapid increase in acitivity at lower temperatures which decreases at higher temperatures. In particular, as for the samples from Examples 12 and 13, it has quite unexpectedly been found that the activity of the inventive catalysts does not decrease upon aging. In fact, as concerns the Co containing sample of Example 16, it is even observed that the maximum activity level in the reduction of NOₓ acutally increases upon aging compared to the fresh sample when employed in selective catalytic reduction.

1: A catalyst comprising particles of at least one ternary intermetallic compound selected from the group consisting of Co₂FeAl, Co₂FeSi, Co₂FeIn, Cu₂FeAl, Cu₂FeSi, Fe₂MnGa, Fe₂MnSi, Co₂CuAl, and Fe₂TiGa,
wherein the particles of the ternary intermetallic compound are supported on a support material, wherein an average particle size D50 of the ternary intermetallic compound particles is from 3 nm to 2 μm.

2: The catalyst of claim 1, wherein the intermetallic compound is a Heusler phase intermetallic compound.

3: The catalyst of claim 1, wherein the support material comprises at least one metal oxide and/or metalloid oxide selected from the group consisting of silica, alumina, silica-alumina, titania, and zirconia.

4: The catalyst of claim 3, wherein the BET surface area of the at least one metal oxide and/or metalloid oxide comprised in the support material ranges from 150 to 500 m²/g, wherein the BET surface area is determined according to ISO 9277 or DIN 66131.

5: The catalyst of claim 3, wherein a weight ratio of the ternary intermetallic compound to the at least one metal oxide and/or metalloid oxide comprised in the support material ranges from 0.5:99.5 to 50:50.

6: A method for the preparation of a catalyst comprising at least one ternary intermetallic compound selected from the group consisting of Co₂FeAl, Co₂FeSi, Co₂FeIn, Cu₂FeAl, Cu₂FeSi, Fe₂MnGa, Fe₂MnSi, Co₂CuAl, and Fe₂TiGa, the method comprising:
adding a support material to a solution comprising a precursor compound for Fe, Co, and Cu, a precursor compound for Mn, Cu, Ti, and Fe, a precursor compound for Al, Si, Ga, and In, and a solvent to obtain a mixture;
evaporating the mixture to dryness to obtained a dried mixture; and
heating the dried mixture in a hydrogen-containing atmosphere.

7: The method of claim 6, wherein the support material comprises at least one metal oxide and/or metalloid oxide selected from the group consisting of silica, alumina, silica-alumina, titania, and zirconia.

8: The method of claim 7, wherein the BET surface area of the at least one metal oxide and/or metalloid oxide ranges from 150 to 500 m²/g, wherein the BET surface area is determined according to ISO 9277 or DIN 66131.

9: A catalyst obtained according to the method of claim 6.

10: A process for the condensation of a carbonyl compound with a methylene group-containing compound, the process comprising simultaneously contacting a carbonyl compound and a methylene group-containing compound with a catalyst according to claim 1.

11: The process of claim 10, wherein the carbonyl compound is selected from the group consisting of aldehydes and ketones.

12: The process of claim 10, wherein the contacting of the carbonyl compound and the methylene group-containing compound with the catalyst is performed at a temperature in the range of from 30 to 150° C.

13: A process for the selective catalytic reduction of nitrogen oxides in exhaust gas, the process comprising performing selective catalytic reduction of nitrogen oxides in exhaust gas with the catalyst according to claim 1.
